(19) United States
(12) Patent Application Publication
(10) Pub. No.: US 2014/0075506 A1
(43) Pub. Date: Mar. 13, 2014

(54) Extensible and Scalable Distributed Computing and Communication Remote Services Platform for Telemetry Collection Adaptive Data Driven Application Hosting, and Control Services

(71) Applicants: Terry L. Davis, Issaquah, WA (US); Brian Marquardt, Seattle, WA (US); Miles B. Miller, Seattle, WA (US); David E. Wall, Bellevue, WA (US); Michelle Selberg, Seattle, WA (US); Paul G. Mallasch, North Bend, WA (US)

(72) Inventors: Terry L. Davis, Issaquah, WA (US); Brian Marquardt, Seattle, WA (US); Miles B. Miller, Seattle, WA (US); David E. Wall, Bellevue, WA (US); Michelle Selberg, Seattle, WA (US); Paul G. Mallasch, North Bend, WA (US)

(73) Assignee: IJET TECHNOLOGIES, INC., Seattle, WA (US)

(21) Appl. No.: 13/615,467

(22) Filed: Sep. 13, 2012

(51) Int. Cl. G06F 21/00

(52) U.S. Cl. 726/3

(57) ABSTRACT

A global, broadband communications and computing system Platform for commercial aircraft selects a “current best” communication link from multiple available links. Onboard network access components, such as Wi-Fi and GSM pico-cells, enable wired/wireless devices to use the aircraft's broadband communications links. The Platform uses virtualization and distributed systems computing technology to create a system of systems that extends an airline company's ground communications and computing systems server(s) onboard aircraft in the fleet, regardless of model, age, or manufacturer. The Platform can host airline operational applications and services onboard the aircraft. An onboard system collects data from multiple aircraft systems, tags it with trusted time and origin metadata, and securely transmits it to a ground portion of the Platform in real time (or as links are available), and receives data for distribution to appropriate onboard systems. Core components on an aircraft are not affected by operation of the Platform.

### BACKGROUND

Existing aircraft flight data and communication systems present a number of problems that have not yet been resolved, as discussed below. Traditional aircraft communications systems support both safety-affecting and non-safety-affecting communications but have limited functionality and capacity. Research and the resulting development of improvements to such systems frequently encourage upgrading installed communications systems software and hardware to enhance the aircraft's capabilities. However, it is difficult to modify aircraft communications systems software and hardware, because any substantive upgrade of an existing aircraft communications system will result in aviation regulatory agencies requiring an associated recertification of all other core aircraft systems using that communication system, due to the way that the current aircraft communications system is architected within the core of the aircraft. The recertification process is both time consuming and relatively costly.

Also, due to the manner in which current legacy communication systems are architected, even small off-board changes to the systems require an airline company to create, test, and certify an “airline modifiable part” before it can be used on an aircraft. For example, once a software part for the communication systems is created, the airline company must certify it and have an authorized mechanic install the update on the aircraft system. This update process for transmitting or receiving just a few bytes of new data can take several weeks to months to complete for an airline's entire fleet, incurring substantial time and cost penalties for the airline company.

Similarly, for a new data security threat affecting aircraft communications, if the threat is deemed serious, the only action an aircraft operator can take is to disable any affected legacy communications link until new software parts—parts that are not vulnerable to the new threat—can be developed, recertified, and manually installed. This process can also be lengthy and costly.

Another problem encountered in aircraft communication systems is the limited access to or sharing of data between each of the installed systems on the aircraft. In contrast to today's land-based data networks, where all systems connected to a network are (at least in principle) able to share information with all other systems on the network, aircraft systems are interconnected to only a small number of other systems, according to their unique data needs. In addition, the time and costs involved in acquiring additional data from these systems are substantial, due to the level of regulatory oversight and physical-installation engineering. This architecture thus severely restricts the ability of a system or application to acquire a different set of data, from a different mix of components, as the air traffic management and airline operational systems evolve.

Traditional aircraft systems are single-purpose, so that each software application is tightly coupled to the hardware on which it executes, which is a result of many factors, including safety considerations, the inertia of past designs, and the relatively recent emergence of modern networked-systems for use on aircraft. The consequence of single-purpose systems is that new or updated software applications require parallel development of both software and hardware components, resulting in substantial expenditures in time and money to implement installation of new communication systems on aircraft. Accordingly, it would be preferable to provide onboard application-hosting capabilities that are coupled with robust data-acquisition and data-exchange services, instead of the limited data access by hardware and systems currently employed.

Recently, new data-link communication options for use with aircraft have proliferated. There are now multiple options on the market for providing broadband Internet Protocol (IP) communications to an aircraft, including multiple satellite-based systems, and systems based on terrestrial cellular technology. Any one solution works reasonably well for its given area of operations. For example, Wi-Fi solutions provide connectivity in the airport ramp area; terrestrial cellular services provide connectivity over the North American continent; and Satcom systems based on geostationary satellites provide substantially global coverage, excluding Earth's polar areas. As a result of these developments—with the limitations noted above, an increasing number of aircraft are being equipped with multiple broadband communications systems. However commercial aircraft have only minimal and narrow bandwidth communications available for the crew to utilize, or for use in transmitting the aircraft systems data or position to ground-based air traffic management or to airline operational systems, due to both the regulatory rules and the aircraft system's architecture. For this reason, although passengers have access to onboard Internet and other wireless communications, these new aircraft broadband services that are provided via mobile radio technology, or satellite networks are not available to an aircraft crew to utilize or for the airline to use for new data gathering, or for applications that can enhance or improve airline operational efficiency. In essence, the aircraft operators' basic interface to their aircraft is still through paper documentation.

Also, there is a substantial complexity associated with managing multiple broadband communications systems, including problems in several areas. Air traffic management services and functions are restricted to the legacy certified communications links; however, much of the data exchanges over these links are not related to air traffic management and could utilize these new faster and cheaper data links. For example, it would be desirable to select and use the current best communication link (for a given aircraft position, flight characteristics, link usage costs, link quality, etc.) in a way that is transparent to applications using the link. It is also desirable to manage the data links so as to satisfy the various (and sometimes conflicting) operational requirements, including authentication/authorization schemes, network filtering policies, traffic prioritization policies, etc., which are imposed by link providers. To achieve better efficiency, it would be desirable to provide legacy onboard systems with a stable unchanging proxy service that maintains the certified interface and protocols protecting the highly certified core aircraft systems from any changes in the communication environment and the associated need to modify or upgrade them. The proxy service could also provide the equivalent of a single sign-on (SSO) service that could authenticate with an onboard Platform component only once, but which would be able to authorize the component to use any data links that are currently operational, without needing the core systems to utilize the link's specific authentication protocols or digital keys, since the specific data link being used can change throughout a given flight and can potentially exceed more than 100 different link providers for an aircraft in international global service.

Likewise, to manage the in-flight change of link providers and links, a dynamic real-time link management service is needed to configure the link network parameters like Internet services, so as to conform to individual nation's air space laws and regulations, and routing. Impliedly, there should also be some mechanism to manage use across the different links, because only a few links are certified for air traffic management communications, and the usage costs vary significantly. And finally, it may be important to expose the current details of link operational characteristics to dependent systems and/or applications, so as to enable appropriate reactions to periods of low bandwidth, periods of no communication link availability, regulatory link use restrictions, bandwidth costs, or various types of link degradation, and/or to address other types of issues that can impact on a specific link that is selected for communication with an aircraft.

### SUMMARY

In consideration of the problems discussed above, a new concept for a “distributed computing and communication service” (which is referred to herein at times as “the service”) has been developed. When applied to aviation to facilitate communication between an aircraft and ground stations, the service is designed to enable maximum integration of both legacy aircraft communication links and protocols and new Internet protocol-based communications. In this application, the architecture merges traditional aircraft/airline supporting ground server and storage with all available communication links to the aircraft, one or more onboard aircraft server units, and one or more aircraft interface devices that implement “read only” interfaces to onboard aircraft systems or data buses. The architecture thereby provides “an Aircraft Service Platform” (sometimes referred to herein as simply “the Platform”, but to be distinguished from other types of platforms, such as the “Customer Service Platform”), fully integrating the aircraft into the ground information technology infrastructure. The architecture of this distributed computing and communication service also centralizes data feeds to all off-board communications through an onboard unit or units that isolate the aircraft core systems from the ever changing communications and computing technology and the associated ecosystem of service providers. The service uses distributed computing to create a “system of systems” that extends ground communications and computing infrastructure to the aircraft in the onboard server node of the Platform. This Platform unifies the entire fleet of aircraft of an airline company into the system of systems, which is able to seamlessly span all aircraft manufacturers and model lines, creating a data collection and computing platform that securely ties together the entire airline's fleet of aircraft with ground support infrastructure extending to the airline's Information Technology (IT) infrastructure. The onboard communications and computing service specifically isolates the “highly certified” aircraft core internal communication systems from any changes caused by new types of off-board communications media, as well as from changes to communications protocols, spectrum, and ground-based aircraft support systems. It also adds the ability to dynamically install new operational support applications, either onboard or on the ground, extensive capabilities to collect aircraft system information, and to present or store such data to onboard or off-board applications or storage.

The new Aircraft Service Platform is a software solution, unlike core aircraft communications systems and servers, and can readily be updated, replaced, or dynamically reconfigured with new links, services, or cyber security functionality, as desired by the aircraft operator. The ability to implement these changes without concern for recertification and all of the time delays and costs associated with that process is accomplished architecturally by creating the Platform as a single digital software service that spans ground infrastructure, communication links, and onboard systems, and which moves some of the traditional ground-based communications functions onboard the aircraft but outside of and isolated from the certified aircraft core systems and servers.

As noted in the Background section above, when the architecture of current aircraft legacy systems is modified, even small off-board changes to an aircraft communications system software require an airline to create, test, and certify an “airline modifiable part.” Once the software part is created, the airline must have an authorized mechanic install the update on the aircraft system. This process can take several weeks to accomplish when updating the aircraft. The update can be as simple as defining a new airline ground server, or adding a configuration for a new airport, or updating one of the dozens of “public key certificates” (the equivalent of an employee or home personal username-password combination) that the aircraft uses to access different link service providers or airport wireless infrastructures. With this exemplary embodiment of the novel distributed computing and communications service that has been developed, the existing certified onboard aircraft systems will require these updates to only a single authentication key set employed between the aircraft systems and the onboard Aircraft Service Platform components, and then updating this single key set only annually or semi-annually, instead of monthly or weekly, as is the case today. All other configuration or link usage changes to aircraft communications services are completely hidden from the certified core systems. Also, all routine operational changes are made within the new onboard Aircraft Service Platform software remotely and can be applied instantly across an entire fleet of aircraft without the need for certification processes or mechanic/technician interaction.

Further, as the Internet changes and evolves, it is highly likely that new cyber threats will find vulnerabilities in existing certified onboard aircraft communications systems and servers. If a threat is deemed serious in a conventional aircraft, the aircraft operator must disable the affected off-board communications link until new software parts, which are not vulnerable to the new threat, can be developed, re-certified, and manually reloaded. As noted above, the process of installing new software components on an aircraft can be time consuming and costly. During the time that a communication link is disabled, which may be for months, the airline must schedule a certified aircraft mechanic to board the aircraft once it lands and manually upload or download data using a “certified maintenance laptop,” as often as required, to retrieve aircraft operational data or update data gathering configurations. In contrast, by using the novel distributed computing and communication service design provided by the Platform, new cyber threats can be countered across an airline's entire fleet as soon as a protection method is defined.

This Summary has been provided to introduce a few concepts of the subject technology in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a schematic functional diagram of an exemplary embodiment illustrating how a new service is employed for communications between various systems on an aircraft and a ground station;

FIG. 2A is a schematic functional diagram illustrating details of the exemplary communication system using the novel software-based service;

FIG. 2B is an exemplary schematic diagram or flowchart of the end-to-end data communications of the Aircraft and Customer Service Platforms in the present exemplary application of this technology to aviation;

FIG. 3 is a schematic diagram illustrating exemplary stacked layers of the Platform;

FIG. 4 is a schematic diagram that illustrates an exemplary 3G modem network device pass through from physical hardware to a virtualized network device;

FIG. 5 is a schematic diagram that illustrates an exemplary system diagram, which includes a Central Node and a Remote Node;

FIG. 6 is an exemplary schematic diagram that shows a Central Node with many Remote Nodes (i.e., nodes on the aircraft in this application of the technology, with data flowing to an isolated Central Node then passed to another Central Node, with Remote Nodes at the airlines, and their supply/service providers receiving the data and providing back application instructions for applications on their aircraft);

FIG. 7 is a schematic diagram that illustrates an exemplary Remote Node with data sources and managed communication links;

FIG. 8 is a schematic diagram that illustrates an exemplary Onboard Network diagram;

FIG. 9 is a functional schematic block diagram of an exemplary generally conventional computing device or computer system that can be employed, for example, for any of the servers or other computers, such as the aircraft server unit or ground facing server unit, in connection with implementing the present technology;

FIG. 10 is a schematic diagram that illustrates an exemplary distributed system diagram;

FIG. 11 is a schematic diagram that illustrates exemplary virtualization and provision of partitions that are employed in the present approach to isolate different software components from one another;

FIG. 12 is a schematic diagram illustrating an exemplary Remote Node used for air traffic management (ATM) messaging;

FIG. 13 is a schematic diagram illustrating exemplary avionics device interface data flows, as used in the application of this technology to the aviation industry;

FIG. 14 is a schematic diagram illustrating aircraft server unit(s) or virtual machine(s), as used in the present exemplary application of this technology;

FIG. 15 is a schematic diagram illustrating exemplary functions performed by a typical aircraft server unit in the present application of this technology;

FIG. 16 is a schematic diagram illustrating applications supporting virtual machines that can be included in an aircraft server unit, as used in the present technology;

FIG. 17 is a schematic diagram of exemplary aircraft facing ground server unit(s) employed in the present exemplary application of this technology;

FIG. 18 is a schematic diagram illustrating an exemplary air traffic management interface server or virtual machine, as can be employed when using this technology in the aviation industry;

FIG. 19 is a schematic diagram illustrating application supporting virtual machines that can be included in one or more exemplary customer/partner facing ground service unit(s), as used in the present exemplary application of this technology; and

FIG. 20 is a schematic diagram showing the services provided by one or more typical customer/partner facing ground service unit(s), as used in the present exemplary application of this technology.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

Although embodiments, figures, and description of this unique distributed platform service use aircraft data collection as an example, it must be emphasized that this same approach can be employed for other types of applications or technologies, and more generally, by any users of distributed systems or equipment, to add new data collection capabilities, applications, cyber security protections, and/or other digital services to legacy systems and equipment, without requiring the replacement of upgrading of those legacy components.

### System Overview

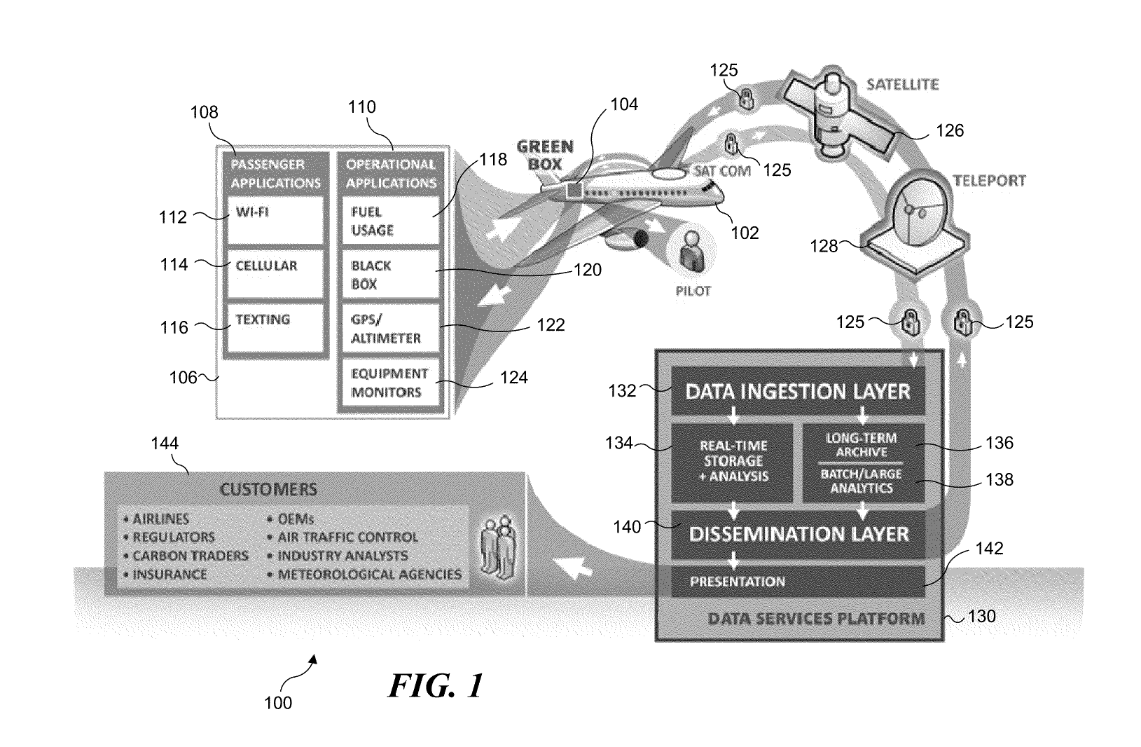

The novel aircraft distributed communications and computing system in FIG. 1 is an integrated, flexible, distributed system of systems that delivers several key capabilities and is designed for deployment on any major commercial aircraft, such as an exemplary aircraft 102. Included on aircraft 102 is a green box 104, which is used for enabling implementation of a plurality of applications 106, including passenger applications 108 and operations applications 110. Passenger applications 108 can include communication functions, such as Wi-Fi 112, cellular telephone 114, and texting 116. Operational applications 110 can include functions such as monitoring fuel usage 118, implementation of a black box 120 application to stream flight data to the ground in real-time, GPS/altimeter instrumentation positioning functions 122, and equipment monitors 124. The passenger application and operational applications illustrated and listed above are simply intended to be exemplary and not in any way limiting of the types of passenger or operational functions that can be implemented in regard to applications 106. Green box 104 is also accessible by the pilots and assigned crew of the aircraft and is coupled to antennas on the aircraft that enable it to communicate using encrypted communications (as indicated by “locks” 125) via one or more satellites 126 and via Teleport Communication Group facilities 128.

A ground data services platform 130 handles these bi-directional encrypted communications. Ground data services platform 130 includes a data ingestion layer 132 to initially process incoming communications received from aircraft 102, including providing for real-time storage and analysis of the data that is received, as indicated in a block 134, and both long-term archival storage 136, and implementation of batch/large analytic functions, as indicated in a block 138. The received communications are then provided to a dissemination layer 140, which further processes the communication data so that it is in a form appropriate to be provided for presentation in a block 142. The received communication data can then be presented to “customers” in a block 144. These customers include, by way of example, airlines, governmental regulators, carbon traders, insurance companies, OEM's, air traffic control facilities, industry analysts, and meteorological agencies, to name a few without any implied limitation.

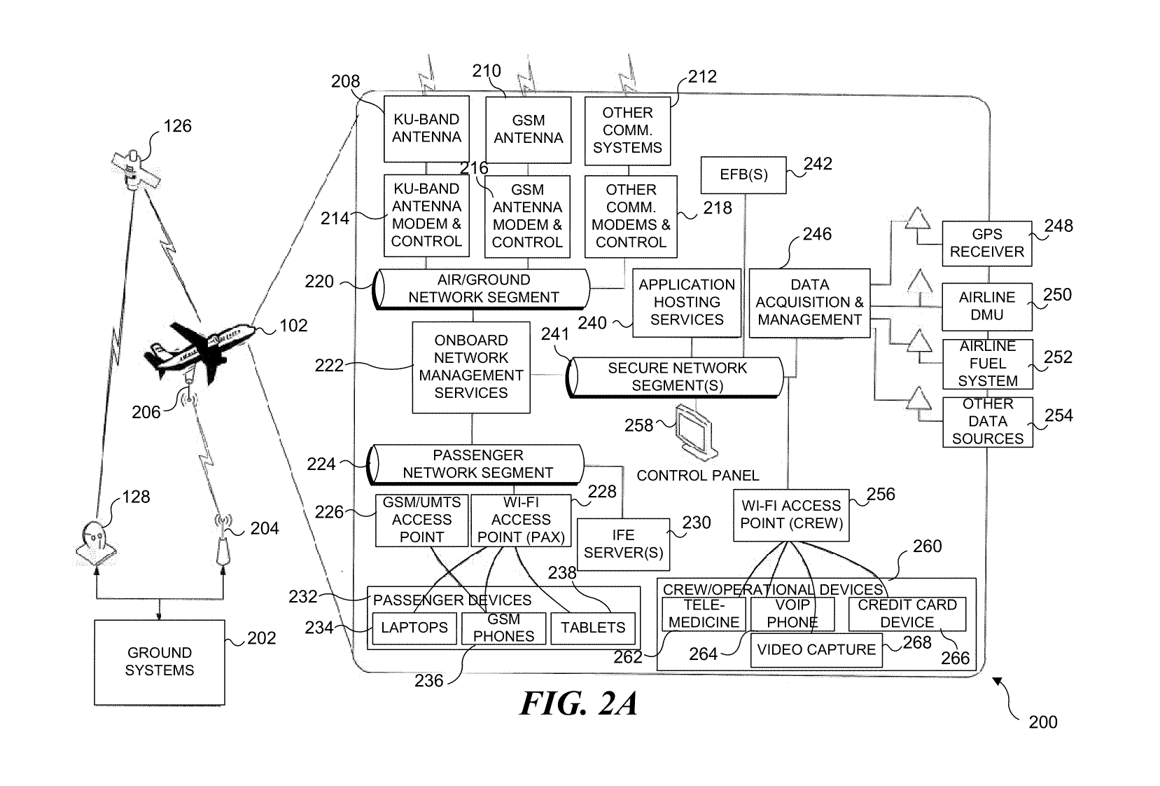

FIG. 2A illustrates further details of the present system, including functions shown in a block 200 that are implemented on aircraft 102. It should be noted that in addition to the communications via satellite(s) 126 and Teleport Communication Group facilities 128 that were discussed above, direct communications with ground systems 202 can be carried out using (one or more each of) a ground antenna 204 and an aircraft antenna 206.

Block 200 refers to a satellite communications antenna 208, a global system for mobile communications (GSM) antenna 210, and any other offboard communication systems 212 that emit and receive RF signals, whether using air-to-ground, air-to-air, or satellite-served links. Ku-band antenna 208 is coupled to a Ku-band antenna modem and control 214 that facilitates communications over this band. Similarly, GSM antenna 210 is coupled to a GSM antenna modem and control 216, which facilitates GSM communications with ground systems 202. There are also other communications modems and controls, as indicated in a block 218. Each of the modem and controls is used to implement various air/ground network segments under the controls of onboard network management services 222. The onboard management services also control various passenger network segments 224, including facilitating a GSM/UMTS access point 226, and a Wi-Fi access point (PAX) 228. By way of example, the GSM/UMTS access point and the Wi-Fi access point can provide Internet or other network communication for crew or passenger devices 232, such as laptops 234, GSM phones 236, and tablets 238.

Another important function implemented in block 200 is application hosting services 240. These services are implemented in connection with one or more secure network segment(s) 241, which are coupled to onboard network management services 222. One or more electronic flight bag(s) (EFBs) 242 can also be provided data communication through secure network segment(s) 241, and thus, be handled by onboard network management services 222. The secure network segment(s) can also be provided for data acquisition and management in a block 246, which by way of example and without any intended limitation, can receive data from a GPS receiver 248, an airline data management unit (DMU) 250, an airline fuel system 252, and from other data sources 254. Data using the secure network segment(s) can also be provided or received by a Wi-Fi access point (crew) 256. This access point can thereby be used for a variety of crew/operational devices 260. Examples of such crew/operational devices 260 include a telemedicine device 262, voice over Internet protocol (VOIP) phones 264, a credit card device 266, and a video capture device 268, without any implied limitation on other types of devices that may also be used. A control panel (e.g., a wireless tablet, or a laptop computer, or another type of computing device) with a display 258 can be included to manage secure network segment(s) 241.

As shown in an exemplary end-to-end flowchart for the Aircraft and Customer Service Platforms in FIG. 2B, the present approach enables centralized, remote, secure management of an airline company's fleet of aircraft by providing a software Aircraft Service Platform and a software Customer Service Platform that communicate with each other. As indicated in a block 272, in regard to airborne systems, devices, or virtual machines 270, data can be sent to or received from aircraft server units or virtual machines 276 through an air traffic management interface server or virtual machine 274. In regard to passenger devices, electronic flight bag(s) (EFBs), existing aircraft servers, and existing network devices 275, data can be directly sent to or received from aircraft server units or virtual machines 267. As indicated in a block 280, data can also be received (only) from aircraft systems, data buses, and networks and provided to aircraft server units or virtual machines 274 via an aircraft interface device server or virtual machine 282. It should be noted that data cannot be transmitted to the aircraft systems, data buses, and networks of the aircraft except for the defined message set passed through the Air Traffic Management interface server or virtual machine 274. Further, data can be transferred bi-directionally between aircraft server unit or virtual machines 276 and legacy aviation, new Internet, and non-Internet protocols and links 278 to aircraft facing ground servers or virtual machines 292.

In regard to ground systems, devices, or virtual machines 284, data in blocks 286 can be sent to or received from customer or partner interfacing ground servers or virtual machines 288, which are coupled to communicate data bi-directionally with customer or partner facing ground servers or virtual machines 290. Customer or partner facing ground servers or virtual machines 290 are also coupled to communicate data bi-directionally with aircraft facing ground servers or virtual machines 292. Legacy aviation, new Internet, and new non-Internet protocols and links 278 can be used for communicating data bi-directionally with aircraft facing ground servers or virtual machines 292, which are part of ground systems, devices, or virtual machines 284.

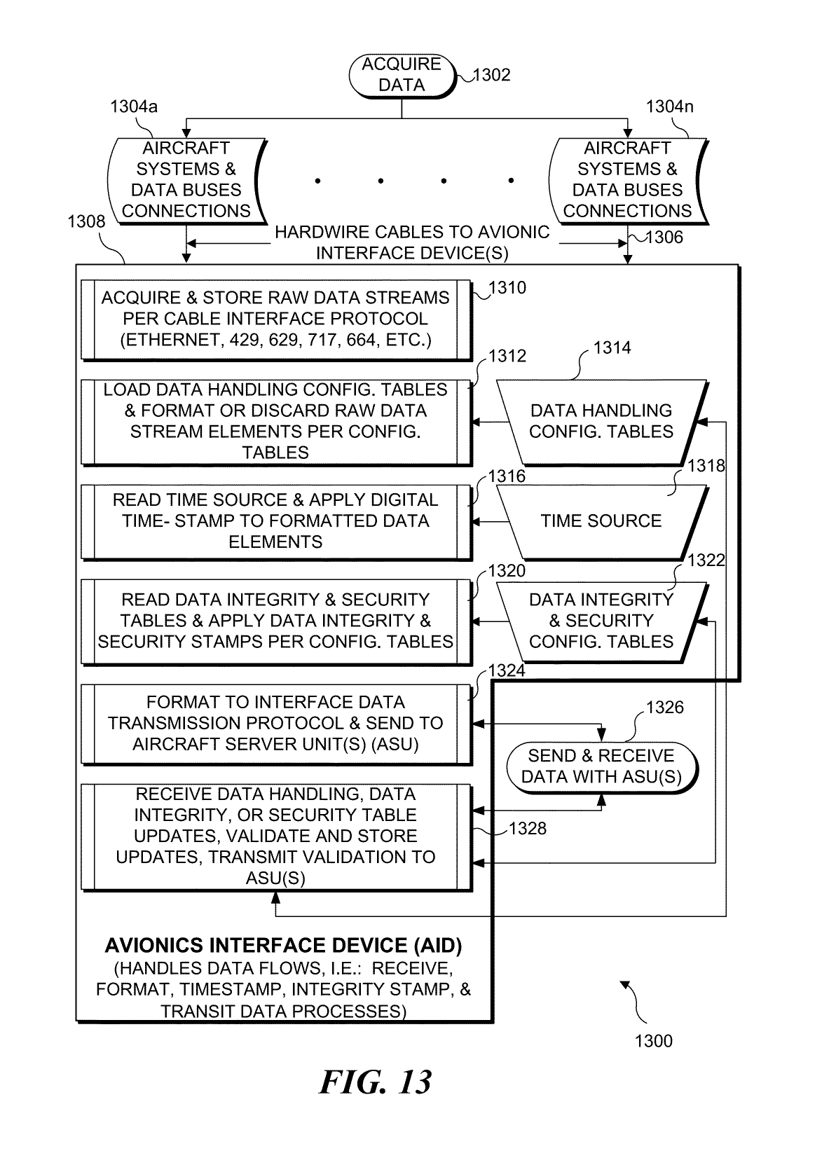

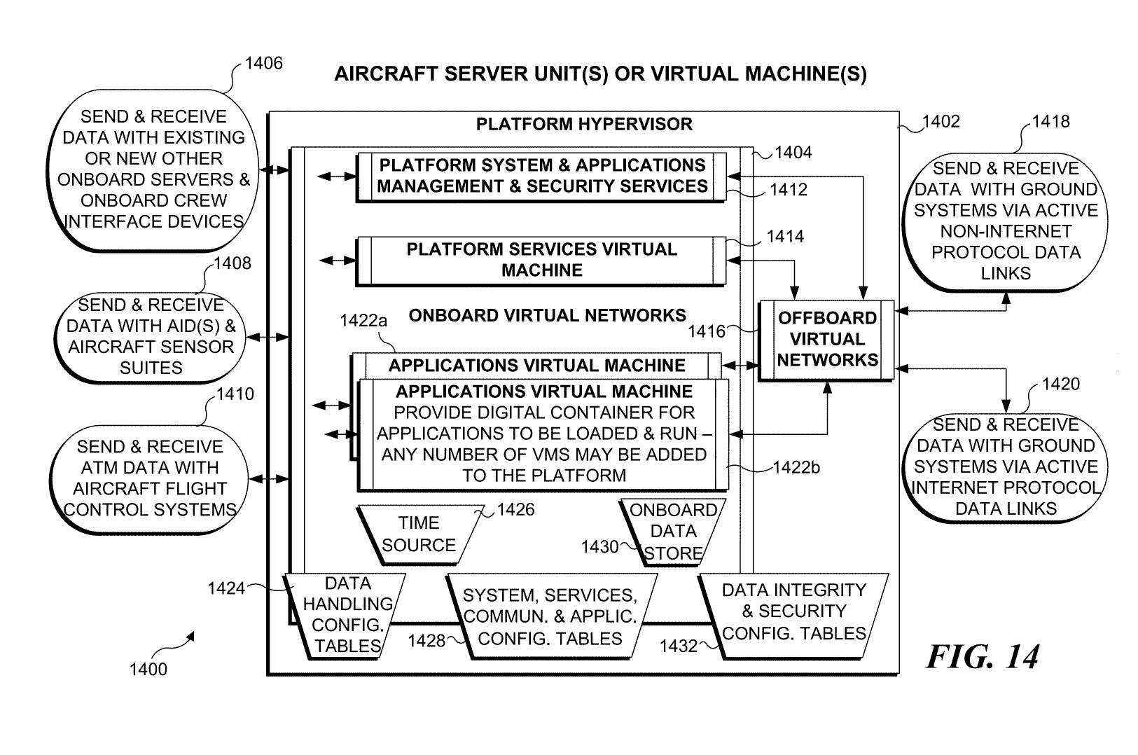

The Aircraft Service Platform thus links onboard aircraft systems components 274, 282, and 276 to a highly secure isolated ground infrastructure comprising aircraft facing ground servers or virtual machines 292, and then to a sister service platform, i.e., to a Customer Service Platform, which includes customer or partner facing ground servers or virtual machines 290 that tie a customer or partner to a software component, e.g., in customer interfacing ground servers or virtual machines 292. The Aircraft Service Platform provides a greatly enhanced onboard data collection system, as discussed below in connection with FIGS. 13 and 14, including the capability to safely and securely integrate via a set of one or more read-only hardware cables and a set of one or more read-only avionics interface device (AID) interfaces with the airframe's core systems via connections to the aircraft data buses. As further explained below, aircraft interface device, server, or virtual machine 282 of the Aircraft Service Platform also handles sending and receiving data using advanced sensor suites, and using other new or existing onboard aircraft servers, which may be provided by others. Onboard aircraft systems components 274, 282, and 278 of the Aircraft Service Platform host applications from the airline or third party providers, and enable them to be dynamically loaded, updated, and initiated at any time, under remote control from aircraft facing ground servers or virtual machines 292. This approach presents an optimized, stable interface for data transfer to the existing aircraft server(s), i.e., servers that are previously installed on the aircraft and are not part of the Aircraft Service Platform, by providing systems to serve as a proxy for offboard communications, thereby optimizing the performance, and minimizing the need for existing aircraft server systems to be manually updated or changed, which often occurs several times a month. The Aircraft Service Platform also provides a greatly enhanced aircraft cyber security capability using Platform Security Services 1412 (discussed below in regard to FIG. 14), which can react in near real-time to new cyber threats to an aircraft.

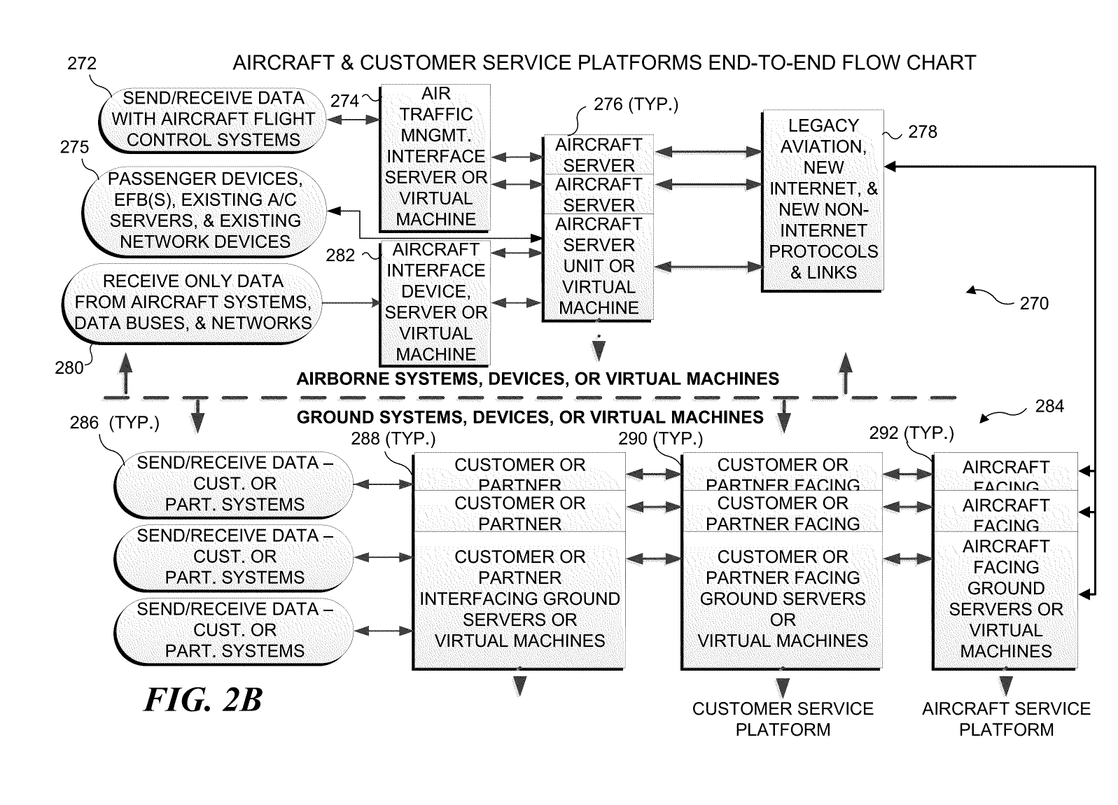

In FIG. 3, the stacking of layers 300 within both the Customer Service and Aircraft Service Platforms is depicted schematically. This layered configuration begins with server physical hardware 314, followed by a hardware usage manager (hypervisor operating system (OS) 308), which includes chipset extensions 310 and central processor unit (CPU) extensions 312. Also included in this example are virtual hardware (HW) devices 306a and 306b (each of which is an abstraction layer), virtual “guest” OSs 304a and 304b, and finally, applications 302a and 302b that use the guest OSs.

Virtual partitioning within the Platforms enables the execution on a single system, of software applications using one or more OSs concurrently and in isolation from other programs. As noted above, the exemplary virtualization implementation depicted in FIG. 3 includes application 302a, guest OS 304a, and virtual HW device 306a, which are isolated from another application 302b, a guest OS 304b, and virtual HW device 306b. Hypervisor OS 308 is a specialized software OS layer used for controlling physical HW, while providing guest OSs 304a and 304b with access to actual underlying physical HW 314 through virtual HW devices 306a and 306b, respectively. The hypervisor OS enables multiple guest OSs 304a-304b to run on the same physical system by offering virtualized HW to each guest OS. Once booted, guest OSs 304a and 304b, and any applications 302a and 302b executing on the guest OSs are unaware of this software partitioning. This virtualization approach enables both the Customer Service and Aircraft Service Platforms to multiply and extends the number of systems within both of the Platforms, maximizing use of available resources, without the need to install additional computing servers. Such partitioning separates and isolates different applications, OSs, disks, and networks for increased security and data integrity, while enabling centralized management of multiple logical servers on a single physical server.

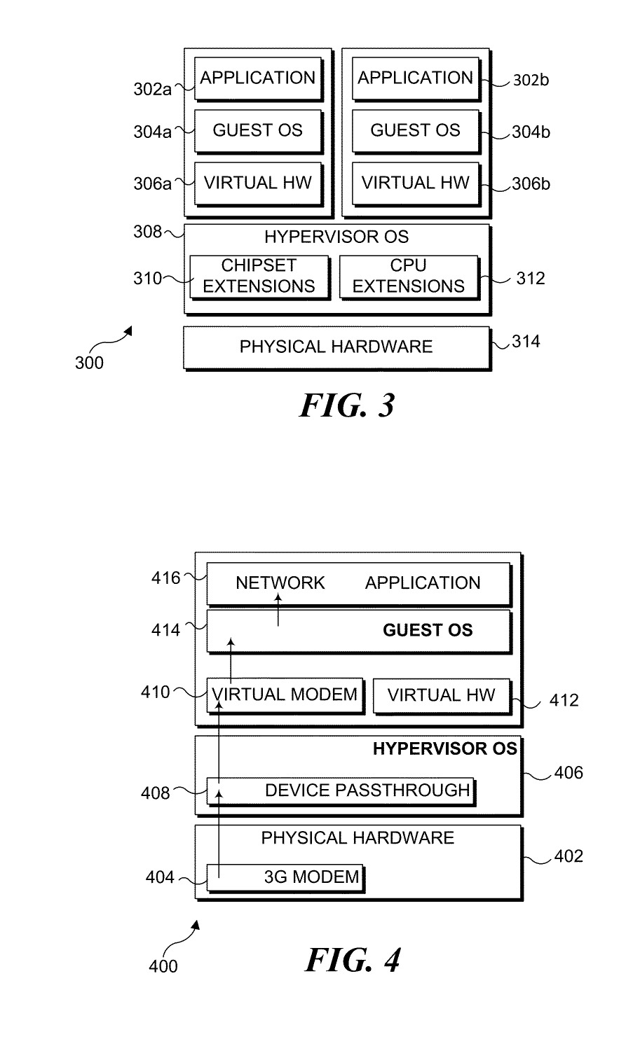

An exemplary embodiment 400 in FIG. 4 illustrates a physical HW 402 that includes a 3G modem network device 404 and shows how data flows through a device pass through 408 in a hypervisor OS 406 to a virtualized network device (a virtual 3G or GSM modem is depicted representing any virtualized network or modem interface) network device 410, and virtual HW devices 412. Data from virtual GSM modem network device 410 is processed by a guest OS 414 and supplied to a network application 416 that is executed by the guest OS.

As discussed above, the closed network system of systems used in the Aircraft Services Platform contains a ground-based service control infrastructure, as exemplified by aircraft facing ground servers or virtual machines 292, which includes servers configuring and controlling the aircraft onboard systems, air-to-ground applications servers serving the applications loaded on the aircraft, aircraft health data harvesting systems, ground data storage, ground-based network and communications equipment required to maintain the links to the aircraft, and operations centers that manage the whole Platform, i.e., for both ground systems and aircraft onboard systems.

The use of virtualization technology to extend the traditional ground-based aviation communication infrastructure to the edge of the aircraft also facilitates the secure communications and data movement between the aircraft and the ground systems, since its communication can be based on Internet standards, which unlike legacy aviation communication links, can readily employ new, highly secure protocols. Existing Internet technologies enable legacy communication protocol messages to be encapsulated within Internet protocol messages, with their original content and form unchanged. When thus encapsulated, an Internet message can be digitally signed to ensure its contents are unchanged on receipt, and it can be encrypted using any of several different Internet standard encryption technologies. Examples of Internet encryption technologies (without any implied limitation) include: “Internet Protocol security” (IPsec), which uses public digital key technology to encrypt messages; Digital Encryption Standard (DES), including various versions, such as “triple DES” (3DES) and CounterMode DES (CM-DES); and, the newer Advanced Encryption Standards (AES) and “Elliptic Curve Encryption.” Numerous Internet encryption technologies can be added, since the Platform uses modular encryption techniques like the Internet Engineering Task Force's Algorithm Agility framework architecture, which readily permits such change and expansion of functionality.

Equally important is that the use of virtualization frees the hardware and communication links used by this new system that is onboard the aircraft from the traditional restraints imposed on aircraft systems. The onboard systems of the closed network system of systems comprising the Aircraft Service Platform provide stable communications links with the core aircraft systems, networks, and buses; while isolating them completely from changes in communication links or protocols. The onboard Platform systems can be changed or upgraded at will, just like traditional ground computing systems, to accommodate changes in the Internet or new communications link types, or protocols. Further, the onboard components of the Aircraft Service Platform can be switched between different aircraft server models or vendors or upgraded, with just minor configuration changes and can add new onboard hosted applications in real-time, or accept dynamic changes to deal with emerging cyber threats. In addition, the Platform functionality enables an aircraft operator to add new communication links to an aircraft at any time, with only minor configuration changes to the aircraft portion of the onboard system, and none of these changes impact the core components of the aircraft, or require recertification.

Both the ground and aircraft components of the respective Aircraft Service and Customer Service Platforms are designed around the “Platform as a service” and “software as a service” concepts and architecture, and this approach provides a further benefit by naturally limiting the “cyber-attack threat surface” or number of ways that the communications and computing system can be attacked. The Aircraft Service Platform software and hosted applications running on the communications and computing system it provides are designed to serve a small set of the specific functions required in aviation, in contrast to traditional OSs that are designed to serve thousands of uses. Both Platforms and their hosted applications can also be more readily hardened, since their design supports naturally limited data communications functions. In addition, they can be readily adapted to use application/service authentication mechanisms.

The closed network of the onboard and aircraft facing ground components of the Aircraft Service Platform thus protects the aircraft by employing a layered security architecture that includes strong authentication of all connected systems and applications, multi-layered encryption, and “a closed network,” which only communicates externally via a “secure message passing gateways” to prohibit any Internet traffic from reaching the aircraft core systems or core data buses. The Aircraft Service Platform uses aircraft hardware systems that can only “listen” to (but not “write” to, or otherwise modify) the core aircraft systems and data buses, and which are physically incapable of sending any signal to a core aircraft system or data bus.

### Exemplary System Diagram

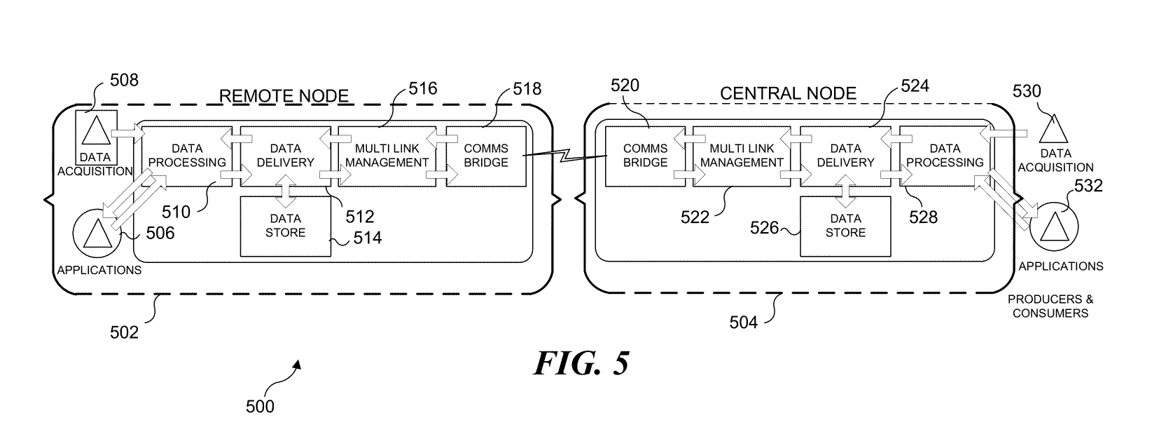

FIG. 5 illustrates an exemplary system diagram 500 that includes a Remote Node 502 in communication with a Central Node 504. The Central Node is a primary system infrastructure; it provides hosting of applications 532 and data acquisition 530 using a data processing function 528. A data delivery function 524 can provide or receive data to or from data processing function 528 and can transfer data to and from a data store 526. A multilink management function bi-directionally communicates data with data delivery function 524 and with a communications bridge 520, which is in communication with a corresponding communications bridge 518 in Remote Node 502. The Central Node thus provides management and systems governance, while complimenting and extending Remote Node functionality by securely obtaining and supplying all Remote Node information and messaging to the aircraft or external consumers. Like the Remote Node, the Central Node hosts applications, manages acquisition, storage, and controls movement of data between producers and consumers, while providing a robust systems management capability. Further, it delivers Platform and customer data and software, command and control messages, and other communications to individual or groups of Remote Nodes from Central Node systems or from outside providers. While Remote Node 502 supports a single remote Platform, the Central Node supports all Remote Node-equipped Platforms and provides a data service framework to external system consumers of the Platform. Each Remote Node 502 includes a data processing function 510 that receives data from data acquisition 508 and can supply or receive data to or from applications 506. Data moves bi-directionally between a data delivery function 512 and data processing function 510, as well as multilink management 516. This multilink management function communicates data bi-directionally with communications bridge 518. Data can be stored or retrieved from a data store 514.

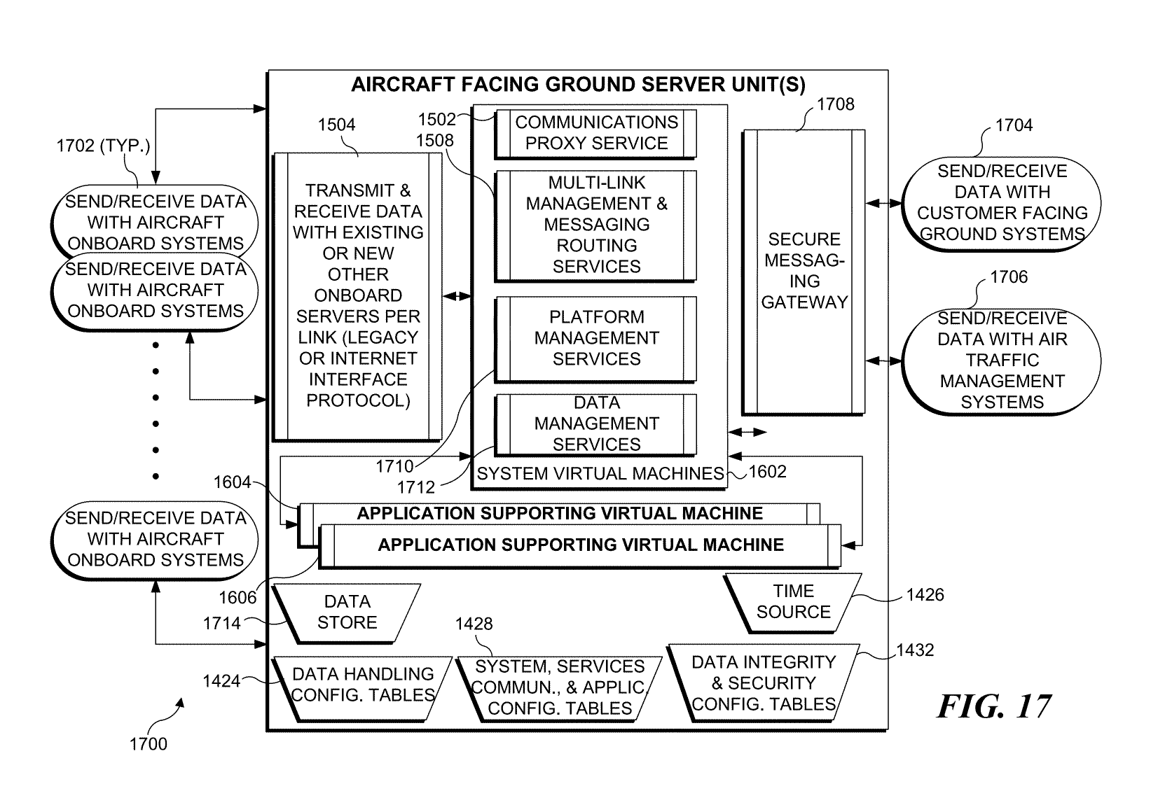

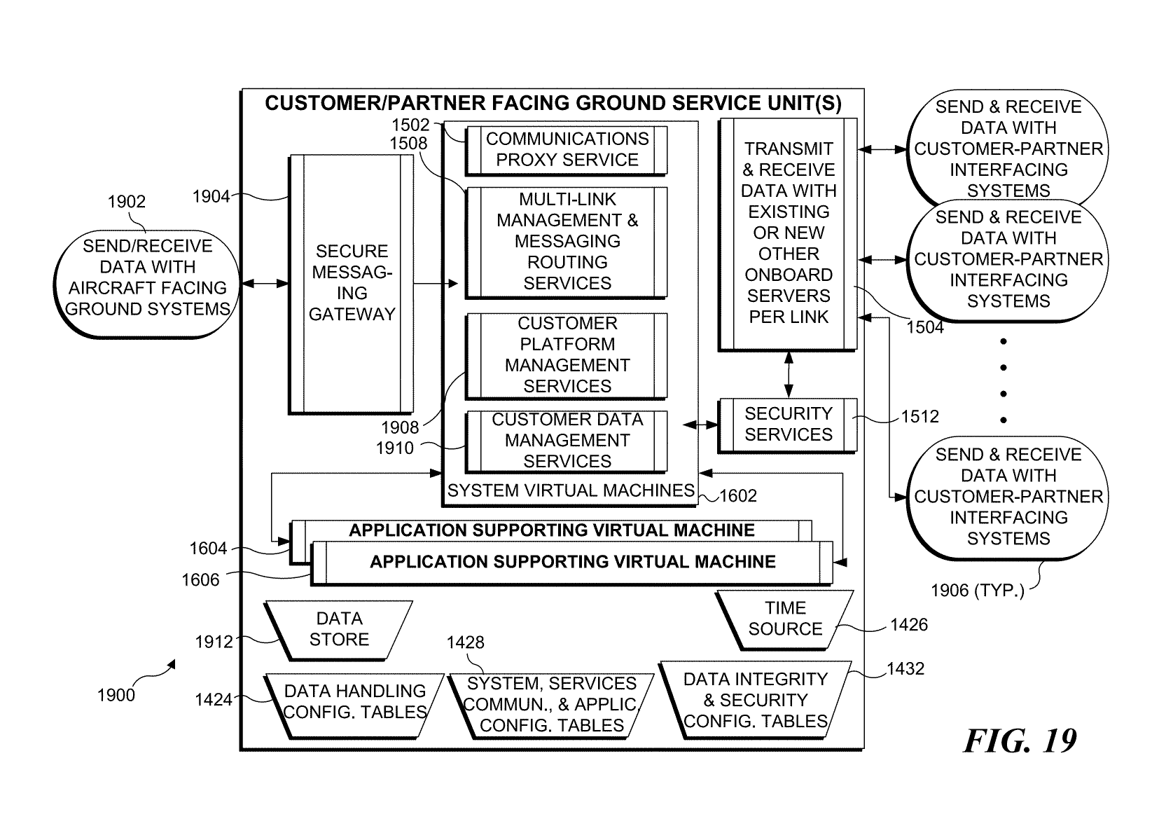

In the Aircraft Services Platform, the Remote Node comprises the onboard aircraft components, and the Central Node comprises associated ground servers, communications, and storage. In the Customer Service Platform, each Remote Node comprises the set of servers or virtual machines interfacing to the airline's back office systems, and the Central node comprises its associated ground services, communications, and storage. The Central Nodes of both types of Platforms are linked by a pair of “secure messaging gateways” 1702 and 1904 (see FIGS. 17 and 19), which are further discussed below.

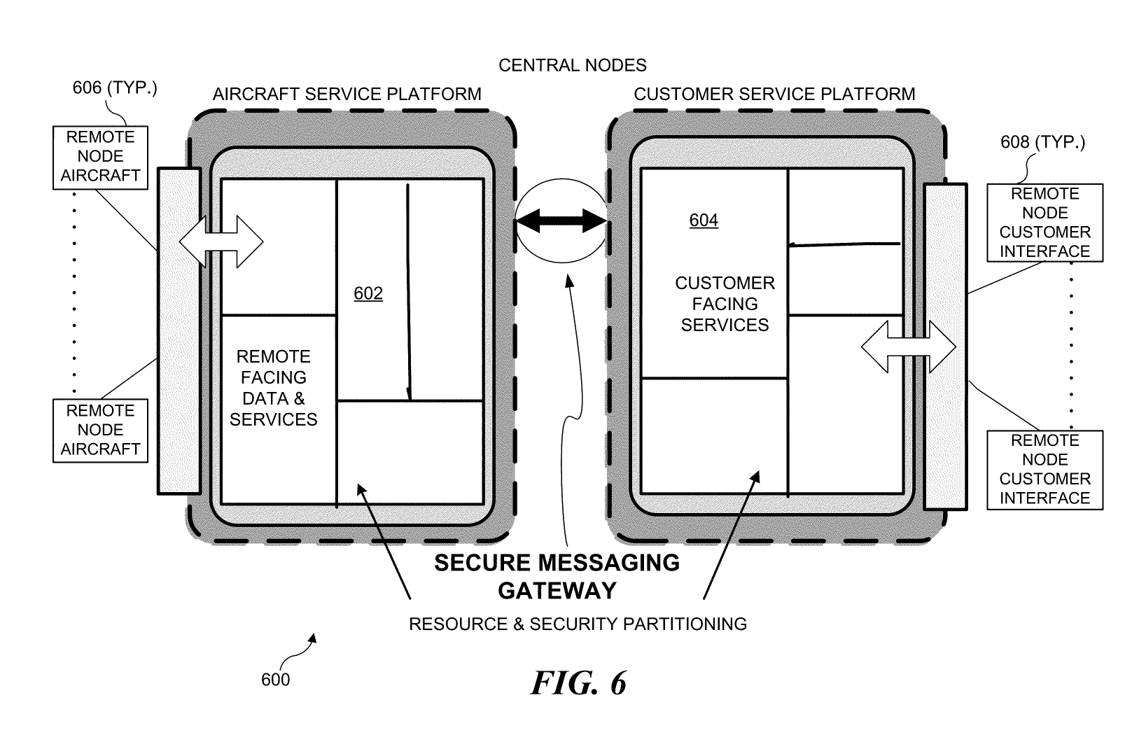

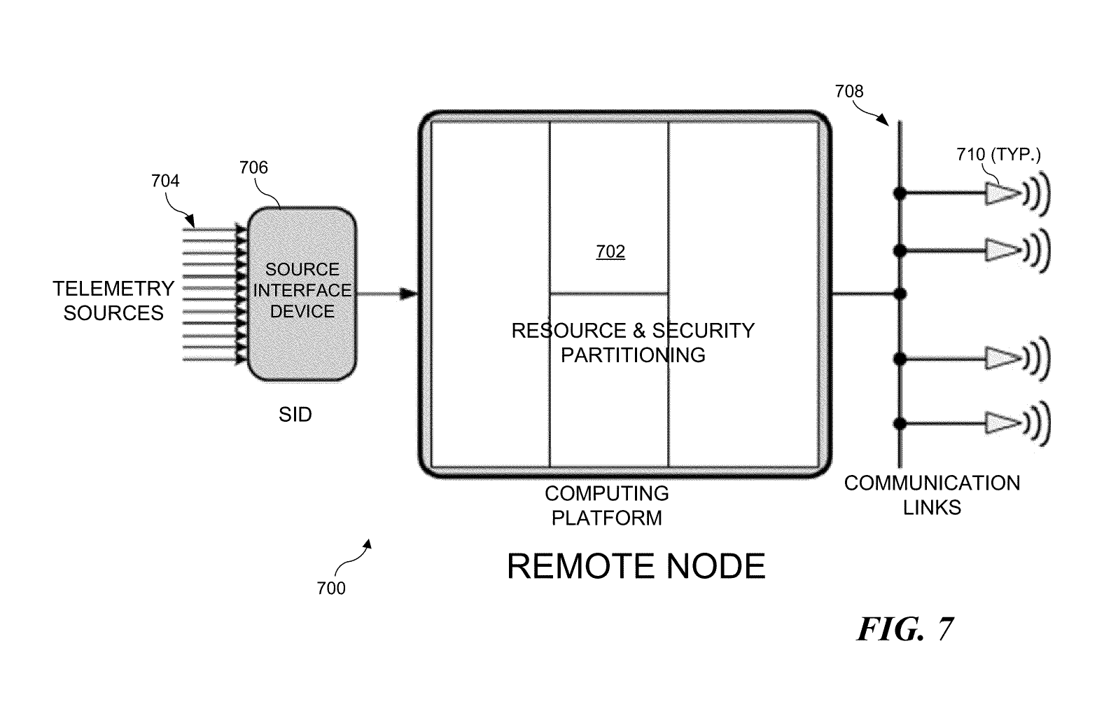

In an exemplary secure messaging gateway 600 shown in FIG. 6, there are two complimentary internal units, each corresponding to a Central Node. The illustration in FIG. 6 shows these two Central Nodes coupled to a number of Remote Nodes. On the aircraft side, Remote Nodes 606 communicate with a Aircraft Service Platform Central Node 602 that services the aircraft. (The Remote Node is expanded further in FIG. 7, which is discussed below.) A Customer Service Platform Central Node 604 communicates with Remote Node customer interfaces 608. Also as shown in FIG. 6, disposed between each of the Central Nodes and the multiple Remote Nodes are several communication links providing data connectivity between the resources.

Each of the Remote Nodes and their connected Central Node collaborate to enable Multi-Link Management and Communication Bridge capabilities. This functionality provides proxy services establishing connections to different link technologies, including legacy aviation link technologies. Examples of such legacy technologies include the “Airborne Call and Reporting System” (ACARS), “Voice Data Link mode 2” (VDL2), satellite links like those operated by Inmarsat and Iridium, and other legacy digital links, as well as newer Ku and Ka satellite links, GSM air-to-ground links, and any other commercial communications links such as 802.11, 802.15, broadband over power (BPL) technology via the aircraft power umbilical at the gate, etc. This functionality simplifies interfaces, controls access and data movement across the links, and dynamically controls the configuration of links and the behaviors of data link usage.

Remote Facing Data and Services in Aircraft Service Platform Central Node 602 aggregate all incoming messages from aircraft Remote Nodes 606 into a central repository. Decoding, decrypting, partitioning, correlating, and de-identifying of the messages are implemented as necessary, prior to the messages being inserted into a data store. For example, “de-identifying” may be necessary if the message includes aircraft data such as the actual precise flight path of an aircraft, since some pilot union contracts prohibit such data from being stored in a way that can identify and tie the data to a specific aircraft and flight. The Customer Service Platform, which includes customer facing services in Customer Service Platform Central Node 604, provides access to this data store along with other Platform resources that enable secure, well-defined interfaces for external data consumption by airlines or other parties through remote node customer interfaces 608. The Customer Service Platform also receives and makes available any external data providers, for consumption by the Remote Nodes or Customer Facing Data and Services components. This Customer Service Platform comprising Central Node 604, ensures all communications between Remote Facing Data and Services in the Aircraft Service Platform and Customer Facing Services in the Customer Services Platform are brokered by the Platform infrastructure, providing centralized data security, consistent application hosting, data and systems management, and isolation of the Aircraft Service Platform from direct interaction with customers' IT infrastructure and the Internet in general.

The separation between the Aircraft Service Platform and the Customer Service Platform, while enabling communications between them through a “secure messaging gateway” shown on FIG. 6, is necessary to ensure that cyber security weakness or lapses in configuration management of the airline/partner back office systems cannot be used to directly mount a cyber attack on the aircraft Remote Nodes. This dual platform architecture minimizes the risk of cyber security attacks on the aircraft.

FIG. 7 illustrates an exemplary Remote Node 700 with telemetry data sources 704 and managed communication links 710. Remote Node 700 represents either the Aircraft Service Platform onboard components, or the Customer Service Platform interfacing servers or virtual machines. In this example, Remote Node 700 provides the Source Interface Device (SID) function described above, and the remote computing, storage, and communication services that the Platforms require.

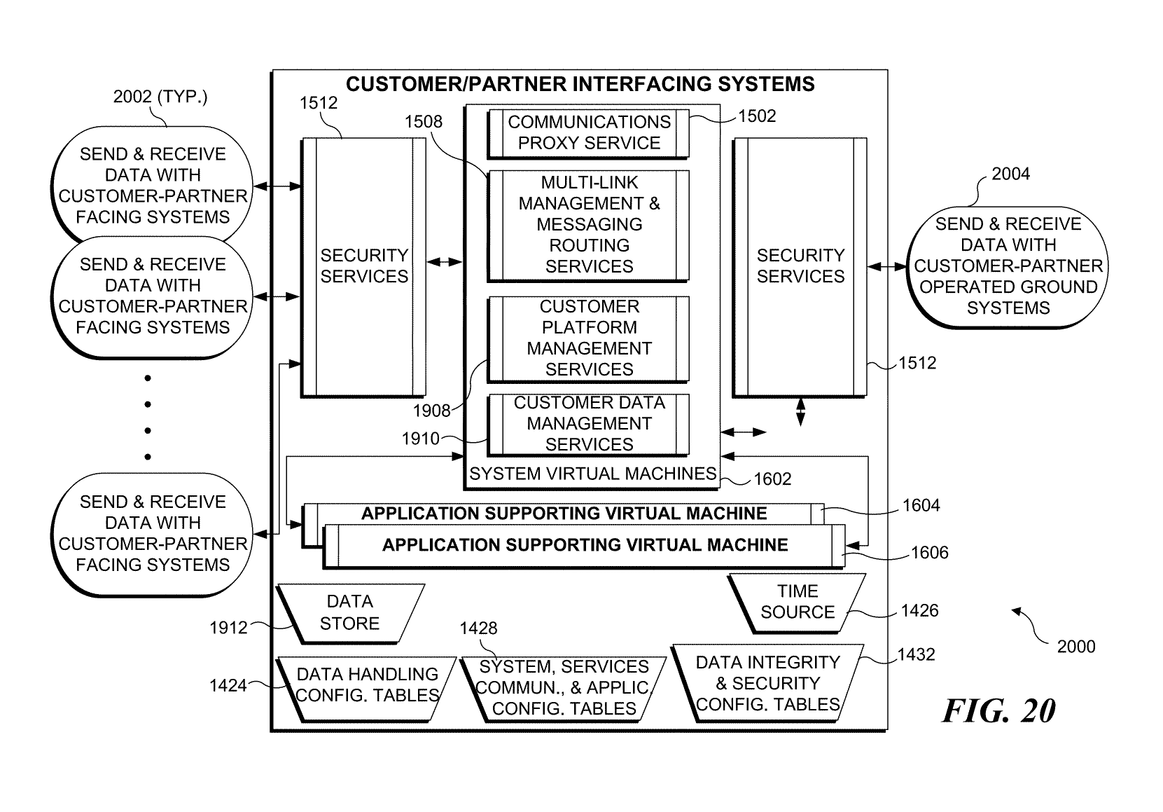

Remote Node 700 collects data from telemetry sources 704 through a Source Interface Device (SID) 706, which in the case of an aircraft server unit that is part of the Aircraft Service Platform, includes an aircraft interface device (AID), an air traffic management interface, and communications proxy service, as discussed below. In the Customer Service Platform, the SID is implemented on a Customer/Partner Interfacing System (shown in FIG. 20) in the onboard data management services. SID 706 abstracts the computing resources in the ASU, and customer service interface server, from the details of the local telemetry and data sources. Through this data abstraction layer, both the Aircraft Service and Customer Service Platforms perform resource and security partitioning 702, to provide uniform data movement through links 708, storage, transformation, and security across all elements of both Service Platforms, enabling all platform elements to be uniformly managed, and providing uniform services to applications—especially those that are distributed between Remote and Central Nodes. Any available communications links 710 configured in the either Platform services can be used to convey the data.

### Onboard Network and Communications Links

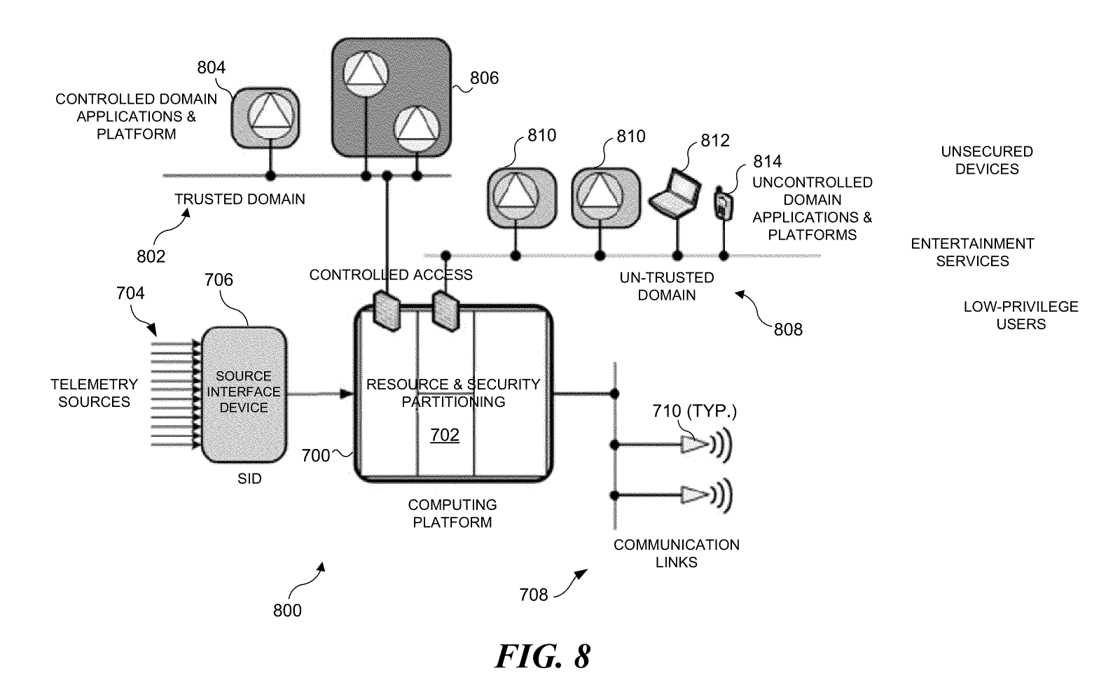

FIG. 8 illustrates a schematic block diagram of an exemplary Onboard Network 800 in connection with the present novel technology. This Onboard Network includes exemplary Remote Node 700, which was discussed above, in regard to FIG. 7. At Remote Node 700, the local configuration of the network resources provides network pathways for the Platform system and hosted and non-hosted applications to use in order to establish secured connectivity to the nearest neighbors in the Onboard Network. The Platform system uses virtualized network resources to connect SID 706 to the computing resources, the internal virtualized resources network to other resources, and the computational resources to communication links 710 that are provided at the Remote Node, which enables additional devices, servers, and communication links to be added to the Platform resources, as necessary.

In addition, the virtualized network is properly partitioned in a similar fashion to the computational resources, in that the network resources appropriately isolate traffic to only flow within a segregated domain, which includes a trusted domain 802 and a separate untrusted domain 808. Servers, applications, and devices local to the Remote Node are separated into different levels of security, access, and protection. Controlled domain applications and platform 804 are included in trusted domain 802. The trusted domain components are collected into a controlled network that includes a virtual machine domain of applications and components 806, providing key communications. (For the Airline application of this technology, these applications and components can include, for example, the Electronic Flight Bag (EFB) Platform, and flight deck tablet devices that provide resources to airline information system applications, such as flight preparation, graphical weather presentations, and other information services.)

In untrusted domain 808, which employs lower security, components are collected into a separate network and virtual machine domain of applications and Platforms 810, which can include, for example, laptops 812 and smart phones 814. (For the Airline application of this technology, by way of illustration, these applications and components might include the In-Flight Entertainment Server and passenger devices providing applications for media consumption, GPS-position enabled software, and/or onboard-to-offboard enabled connected applications.) These untrusted components are network isolated and can use Internet “tunneling” technology for communications, which is similar to “virtual private networks,” but is used to protect intermediate systems that are being used from any aware contact with the communications they are carrying.

The “untrusted” applications and passenger communications of untrusted domain 808 are never allowed on the same virtual networks as the “trusted” components and applications of trusted domain 802 and are entirely contained in the Remote Nodes. The untrusted components are never allowed to communicate with any part of a Central Node or any component within a Remote Nodes “trusted” domain.

### Exemplary Computer System

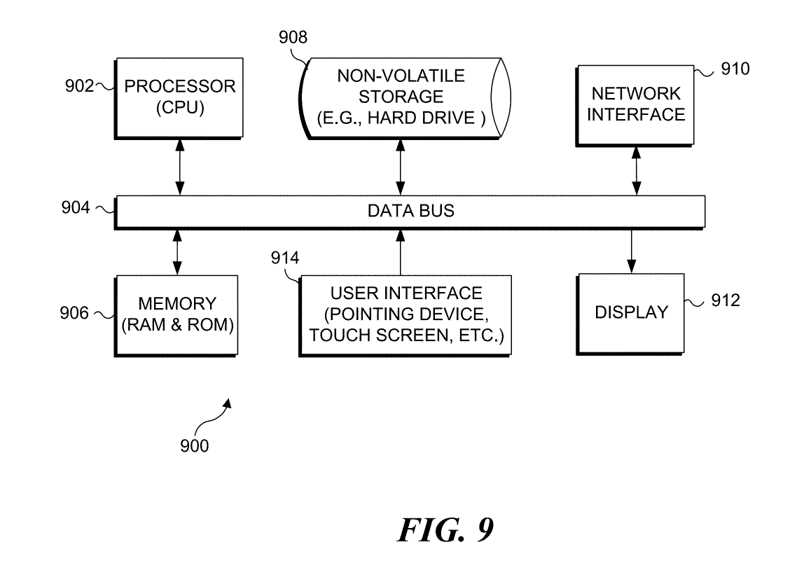

FIG. 9 illustrates an exemplary computer system 900 that can be employed as a computing device or server, in connection with implementing any component of the present system. For example, computer system 900 can be employed as an ASU or as a ground server. The computer system includes a processor (or CPU) 902 that is coupled in bi-directional communication with a data bus 904. The data bus is also coupled in bi-directional communication with a memory 906 that includes both read only memory (ROM), and random access memory (RAM) or other type of dynamic storage for both data and machine executable instructions that are executed by processor 902, and with a non-volatile storage 908, which may include a magnetic or optical storage medium and a corresponding drive (e.g., a hard drive). Data and machine executable instructions can be stored on non-volatile storage 908. Computer system 900 can execute appropriate machine instructions to implement any of the exemplary functions described herein, in regard to server units or other types of computing devices used in the present system.

A network interface module 610 can be included to enable the computer system to communicate with other computing devices or storages over a network, and the communication can be over either hardwired or wireless links. The network interface module may include a modem, or a network interface card for coupling to an Ethernet, a token ring, or other type of local area network, or to either a wide area network or to the Internet via air-to-ground, satellite, or wired communications links (while the aircraft is on the ground). The network interface module enables computer system 900 to upload and/or download data and/or software programs by communicating with other computer systems, or servers, or storage devices. It also provides for either client-to-server, or peer-to-peer applications to communicate between Remote Nodes or between a Remote Node and a Central Node.

Bus 904 may include an input/output bus and graphics adapter (not separately shown) for coupling to a display 912 that displays graphics and/or text. A user interface 914 may be included for providing input of alphanumeric text and controlling the operation of computer system 900 and may include a pointing device, such as a mouse, a touch pad, a trackball, or other mechanism, for use in controlling a cursor and making selections for input to the computer system.

### Exemplary Distributed Application Design Concepts

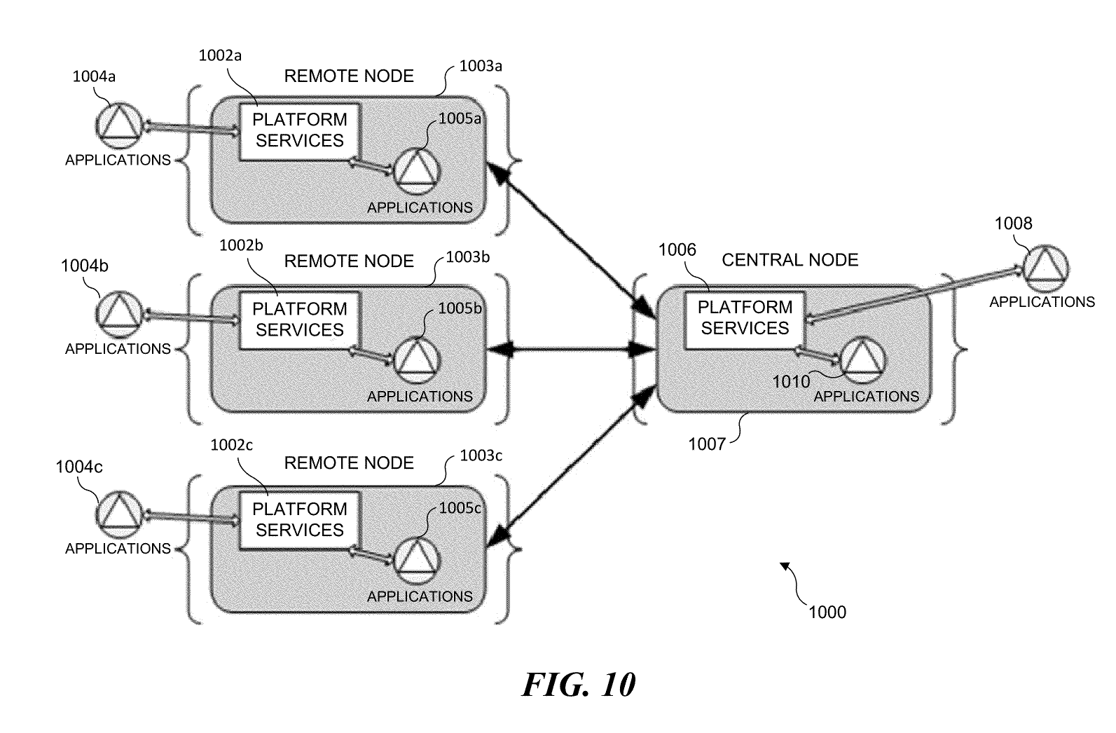

FIG. 10 illustrates an exemplary Distributed System Diagram 1000, which can be used in the present approach. Both the Customer Service and Aircraft Service Platforms are distributed systems, comprising multiple software elements that are deployed on multiple HW elements. The software elements may be deployed on one or more remote HW nodes, such as Remote Nodes 1003a, 1003b, and 1003c (some of which are mobile), on one or more Central Nodes, such as Central Node 1007, and, in many cases, on both Remote and Central Nodes. Further, the software elements of the Platforms deliver software services, such as Platform services 1002a, 1002b, and 1002c (on the Remote Nodes), and 1006 on the Central Node, which address recurring challenges faced by application developers, including data management, systems management, and configuration management. These services are implemented as software interfaces that support machine-to-machine communication and satisfy various needs of dependent applications. By using the software services provided by the Platforms, developers are able to spend less time building foundational capabilities for their application(s) and are free to focus on the core logic of those application(s).

The following is a partial list of services that are provided by the Aircraft Service Platform:
Access real-time telemetry data from one or more monitored assets;
Access historical telemetry data from one or more monitored assets;
Determine when updated non-telemetry data is available;
Report application status, version, or fault information; and
Determine whether software updates are available for a specific application.

Because the services of the present system are accessible over computer networks, applications can be located anywhere, so long as they can connect to the Platform over an appropriate communications network (including private networks or over the public Internet) and tolerate the lack of immediate communication link availability, or its limited performance, or its permitted uses through multi-link management and messaging routing services 1508. The Platform delivers an equivalent set of services on Remote Nodes and Central Nodes, to enable the broadest possible set of applications, while minimizing the performance and communications constraints of distributed architectures. Applications 1010 may be deployed within the Central Node(s), and applications such as applications 1005a, 1005b, and 1005c can be deployed within the Remote Nodes. In the data centers of customers or in the data centers of their partners, applications 1004a, 1004b, and 1004c can be deployed using the present system. Applications consume services that are running in either a Remote Node or a Central Node, as determined by “optimum” access patterns that consider network proximity, intervening network constraints, and tolerance for latency. In general, applications such as applications 1005a, 1005b, and 1005c that are deployed within the Remote Nodes (or within a monitored asset) will consume services that are deployed on the Remote Node, while applications outside of the Remote Node (such as applications 1010 deployed in the Central Node) will consume services that are deployed on the Central Node.

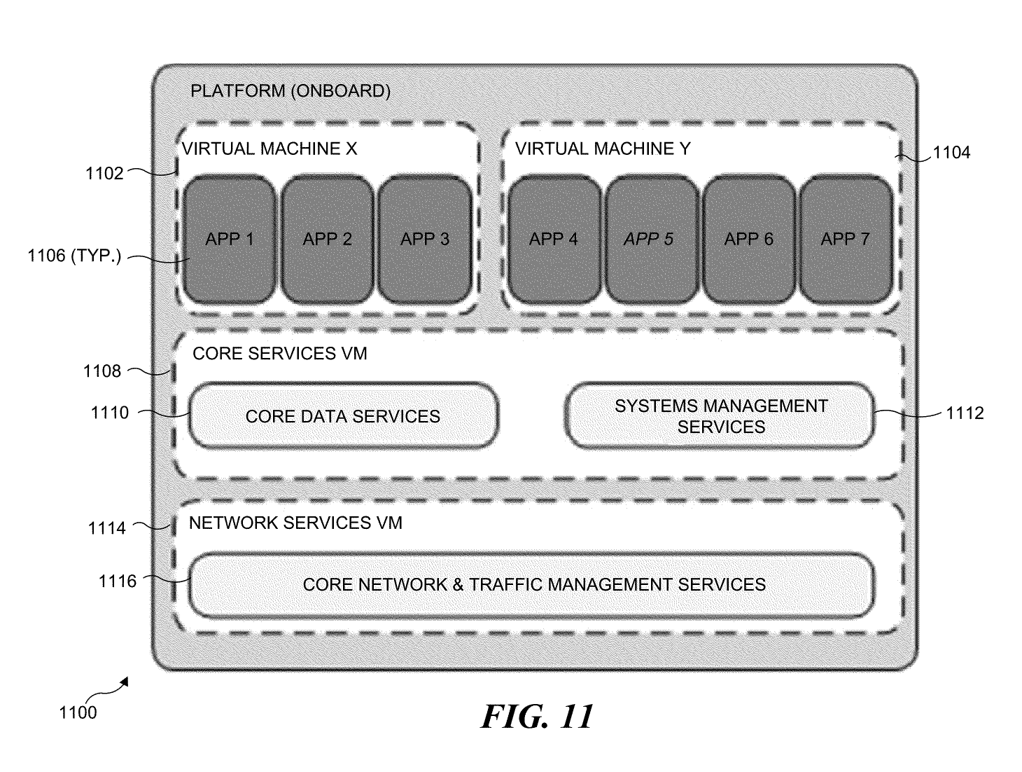

Virtualization technology, as shown in an exemplary Onboard Platform 1100 of FIG. 11, enables the Platform components to be used on most modern hardware vendors' server systems. It also enables the Platforms to be readily updated to accommodate newer, lighter, cheaper, and/or more powerful servers as they become available, to further enhance an aircraft's capabilities. Onboard Platform 1100 can include a plurality of virtual machines 1102 and 1104, respectively identified as a virtual machine X and a virtual machine Y. Virtual machine X is shown as implementing a plurality of applications 1106, including applications 1, 2, and 3, while virtual machine Y is shown implementing applications 4, 5, 6, and 7. Each virtual machine is independent of the other, but may have access to a core services virtual machine 1108 that interacts with core data services 1110 and systems management services 1112. Also included in Onboard Platform 1100 is a network services virtual machine 1114, which interacts with core network and traffic management services 1116.

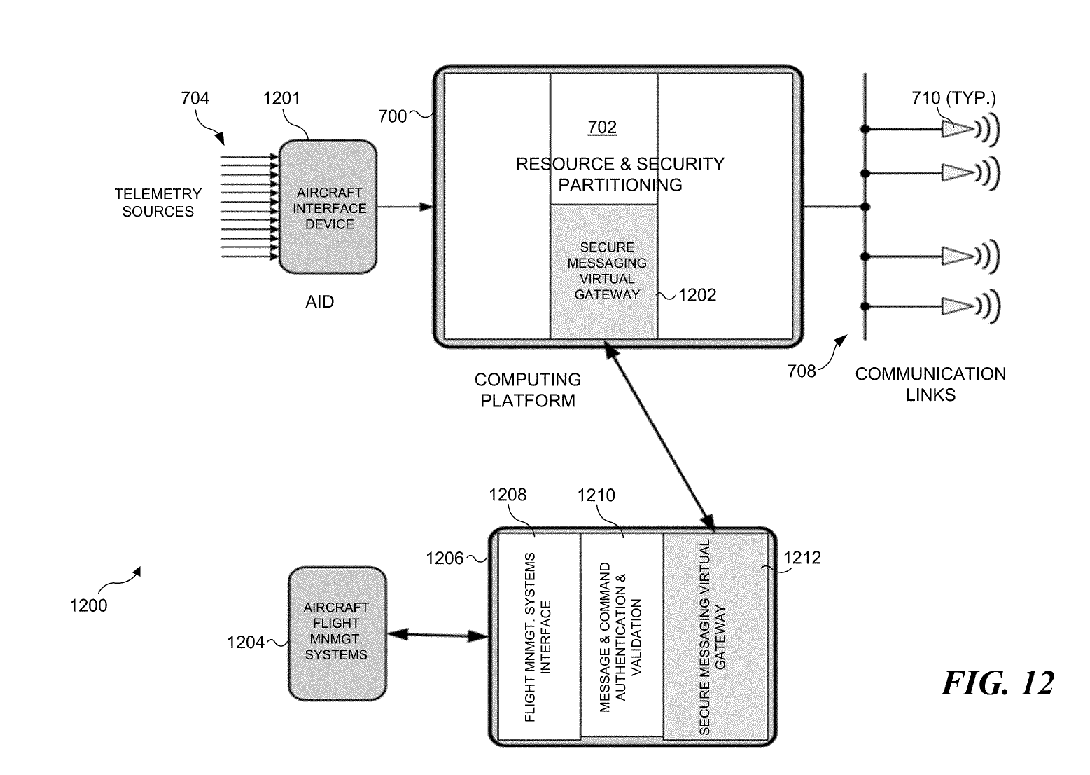

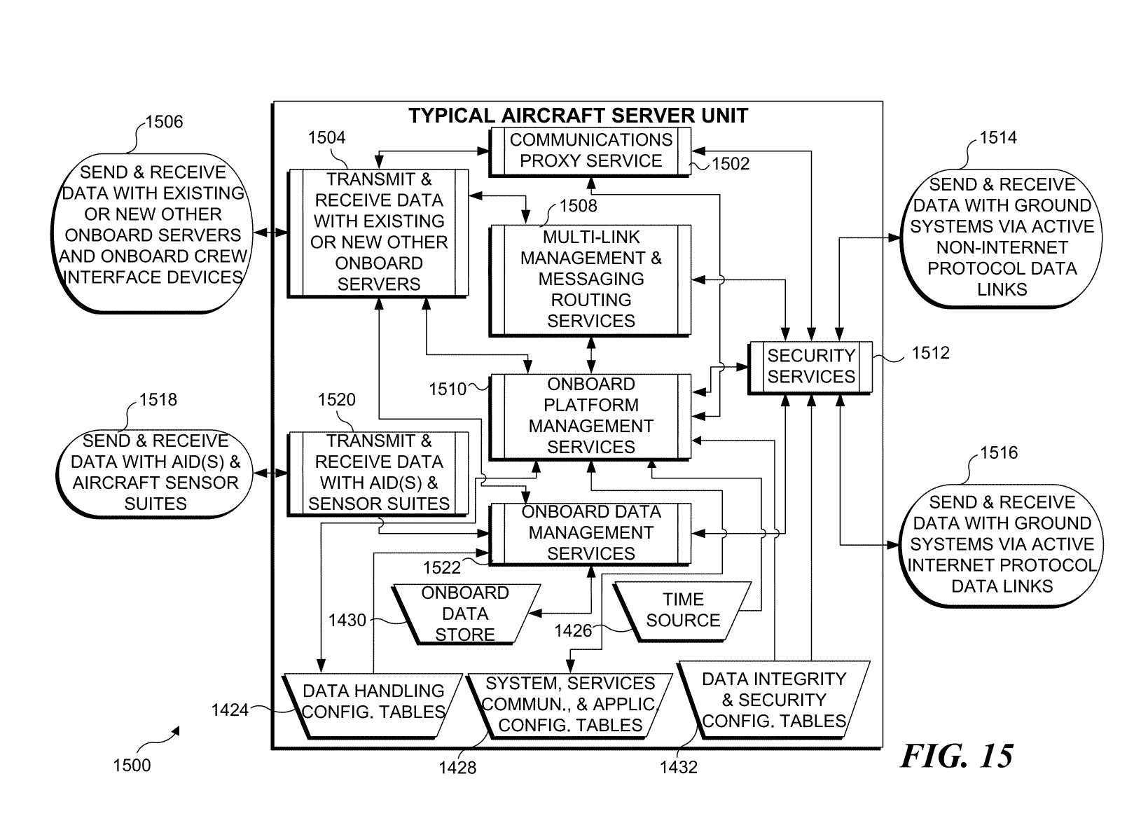

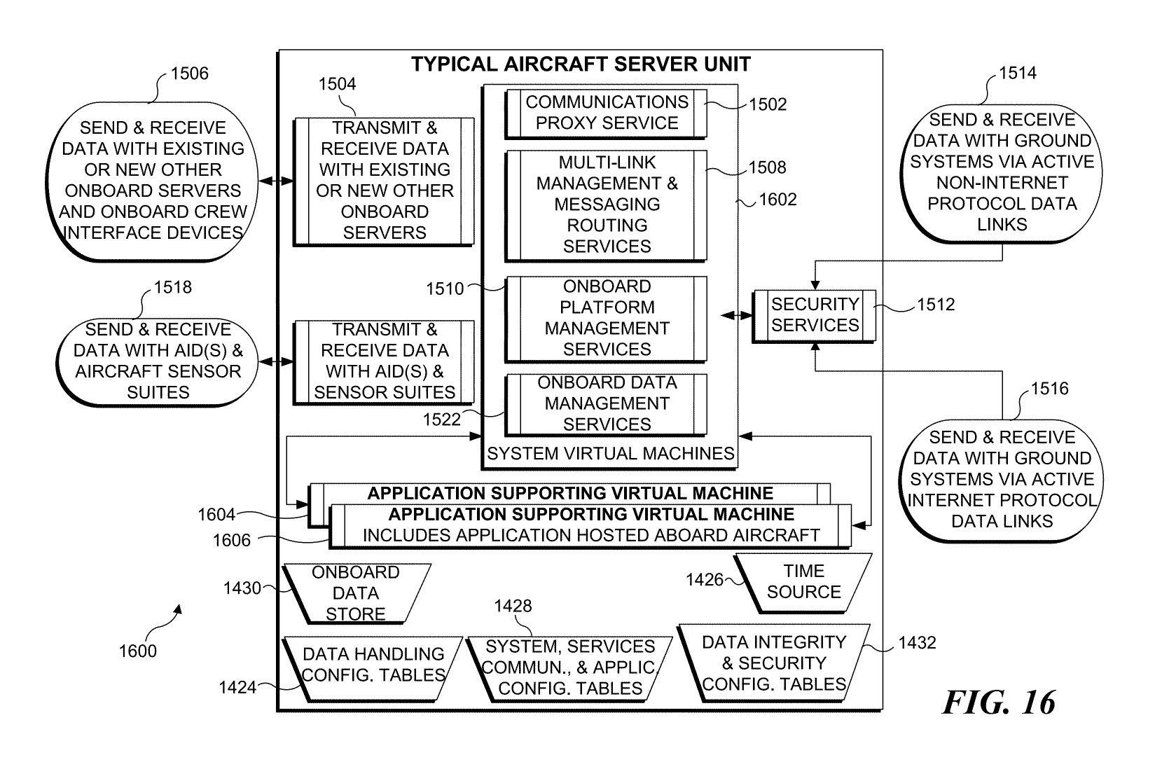

The use of Remote Node 700 for air traffic management is illustrated in an exemplary schematic diagram 1200 in FIG. 12. An AID 1201 is specifically identified in this Figure (rather than the more general SID 706). In this application, the Remote Node implements a secure messaging virtual gateway 1202. Secure messaging virtual gateway 1202 is in bi-directional communication with a corresponding secure management virtual gateway 1212 in air traffic management interface server or virtual machine 274 (FIG. 2B), which corresponds to a component 1206 of the Platform, enabling a secure “next generation” air traffic management communication capability. This secure management virtual gateway permits the transmission of defined messages and associated authentications (which were handled previously by only mechanic-installed and certified hardware) to aircraft flight management systems 1204, using a flight management systems interface 1208 and a message and command authentication and validation module 1210 within component 1206. A “secure application messaging portal” resides in a security services module 1512 (shown in FIG. 15, which is discussed below) within an aircraft server unit 1600 (shown in FIG. 16 and also discussed below) and is linked to secure messaging gateway 1212 in air traffic management interface server or virtual machine 274. Message and command authentication and validation module 1210 implements final message validation, and hysteresis checking is implemented before any message is passed to aircraft flight management systems 1204.

A global two-way communications system for commercial aircraft can readily be implemented with the new communication and computing systems, using a bus agnostic protocol read-only hardware aviation interface device (AID) 1308, as shown in an exemplary schematic diagram 1300 in FIG. 13. (A corresponding SID 706 is shown in exemplary schematic diagram 700 in FIG. 7.) AID 1308 is employed to gather data in real-time that is either flowing on core aircraft systems and core data buses via connections 1304a-1304n, or is recorded within other systems of an aircraft (not shown). The AID is coupled to onboard aircraft systems and facilitates a service for collection of data from the core aircraft systems core data buses through connections 1304a-1304n, and through a set of computing processes (which are indicated in blocks 1310, 1312, 1316, 1320, and 1324). These processes can exist either in AID 1308, as shown in FIG. 13, or in an ASU or virtual machine 1400, which is illustrated in FIG. 14 and discussed below. The corresponding SID (e.g., SID 706) may interface to custom airline ground system communications like ACARS or in an alternative application of this technology, to custom control communications in a power generation station.

Block 1310 provides for acquiring and storing raw data streams per a cable interface protocol, e.g., Ethernet, Aeronautical Radio Incorporated (ARINC) protocols 429, 629, 717, 664, etc., without any intended limitation. Block 1312 provides for loading data handling configuration tables 1314 and then formatting or discarding raw data stream elements in accordance with the configuration tables. In block 1316, a time source 1318 is read, and a digital time stamp is applied to the formatted data elements. In block 1320, data integrity and security configuration tables 1322 are read, and data integrity and security stamps are applied to the data in accordance with requirements set forth in the data integrity and security configuration tables. Block 1324 provides for formatting the data produced by the preceding processes to a desired interface data transmission protocol and sending the formatted data to one or more ASUs. Data can be either sent or received, as indicated in a block 1326. Further, a block 1328 provides for received data handling, handles data integrity and security configuration table updates, validates and stores the updates, and transmits the validation to the ASU(s).

FIG. 14 illustrates ASU(s) or virtual machine(s) 1400, while FIG. 15 illustrates an exemplary (or typical) ASU 1500 that can be employed in the present technology. In FIG. 14, a platform hypervisor 1402 includes onboard virtual networks 1404 that are in bi-directional data communication with existing or new other onboard servers and onboard crew interface devices, as indicated in a block 1406. This group of functional components can also send and receive data with AID(s) and aircraft sensor suites, as indicated in a block 1408, and can send and receive ATM data with aircraft flight control systems, as indicated in a block 1410. Onboard virtual networks 1404 include platform system and applications management and security services 1412, platform services virtual machine 1414, and applications virtual machines 1422a, and 1422b (by way of example). The applications virtual machines provide digital containers or virtual HW for applications to be loaded and run. It should be understood that any number of such applications virtual machines may be added to the Onboard Platform. Also included in platform hypervisor 1402 are data handling configuration tables 1424, a time source 1426, system services, communication, and applications configuration tables 1428, an onboard data store 1430, and data integrity and security configuration tables 1432. Offboard virtual networks 1416 associated with platform hypervisor 1402 communicate data bi-directionally with ground systems via active non-Internet protocol data links, as indicated in a block 1418, and similarly, with ground systems via active Internet protocol data links, as indicated in a block 1420.

A typical ASU 1500, which is shown in FIG. 15, includes a communications proxy service 1502 that is used in connection with a block 1504 for transmitting and receiving data to or from existing or to and from new other onboard servers (i.e., servers that are not part of the Platform). Similarly, block 1504 is coupled to send and receive data with existing or new other onboard servers and onboard crew interface devices, as indicated in a block 1506. Also coupled to block 1504 are multi-link management messaging routing services, as shown in a block 1508, and onboard data management services, as shown in a block 1522. Onboard data management services in block 1522 can transmit and receive data with AID(s) and sensor suites 1518, as indicated in a block 1520. The data managed by onboard data management services in block 1522 can be stored in an onboard data store 1430. Data handling configuration tables 1424 are used by the onboard management services in block 1522 and by onboard platform management services in a block 1510, to control data management. Time source 1426 is also coupled to onboard platform management services in block 1510, to provide time stamps for data. Security services module 1512 uses data integrity and security configuration tables 1432 for controlling the security of data that is transferred bi-directionally with ground systems via active non-Internet protocol data links 1514, and with ground systems via active Internet protocol data links 1516. The security services module is also employed by communications proxy service 1502, multi-link management and messaging routing services in block 1508, onboard platform management services in block 1510, and onboard data management services in block 1522.

Since aircraft are often simultaneously using multiple communications services, multi-link management and messaging routing services in block 1508 (FIG. 15) can be used to select the best communications channel, based on the current flight characteristics. Continuous “location aware” management of link configurations, applications, and link cyber security is achieved in platform system and applications management and security services 1412 (FIG. 14), which dynamically re-configures these elements to ensure conformance to “National Airspace Regulations” of the various nations/states over which the flies. It also ensures connectivity, regardless of the unique link providers used by the aircraft in flight, as they move between regions or employ local airport connectivity services that are available. The Aircraft Service Platform is open and scalable so that it is able to deliver local new applications and services or migrate existing applications, as shown in FIG. 10, where and when they are needed, either on the airborne or ground components of the Platform.

FIG. 16 illustrates other functional capabilities of a typical ASU 1600. The ASU executes system virtual machines 1602, which provide communications proxy service 1502, multi-link management and messaging routing services 1508, onboard platform management services 1510, and onboard data management services 1522, all of which are discussed herein. As an example, system virtual machines 1602 interact with applications supporting VMs 1604 and 1606, although many more applications supporting VMs can be included. Other aspects of typical ASU 1600 are as described above in connection with FIG. 15.

An exemplary aircraft facing ground server unit 1700 is illustrated in FIG. 17. As indicated in blocks 1702, the aircraft facing ground server units can send and receive data bi-directionally with aircraft onboard systems. Many functions implemented by the aircraft facing ground server unit are comparable to those of the ASU, as discussed above. To emphasize these similarities, the same reference numbers are used in aircraft facing ground server unit 1700 as were used in connection with the similar components of ASU 1500 and in typical ASU 1600. Thus, aircraft facing ground server unit 1700 includes system virtual machines 1602, that include communications proxy service 1502, multi-link management and messaging routing services 1508, all of which perform similar functions as in the ASUs discussed above. Also included are platform management services 1710, and data management services 1712. System virtual machines 1602 interact with application supporting VMs 1604 and 1606, for example, just as noted in regard to typical ASU 1600. Also included in aircraft facing ground server unit 1700 are data handling configuration tables 1424, a data store 1714, system services communication, and application configuration tables 1428, time source 1426, and data integrity and security configuration tables 1432. A secure messaging gateway 1708 is provided to securely handle sending and receiving data with customer facing ground systems, as indicated in a block 1704, and for securely handling sending and receiving data with air traffic management systems, as indicated in a block 1706.

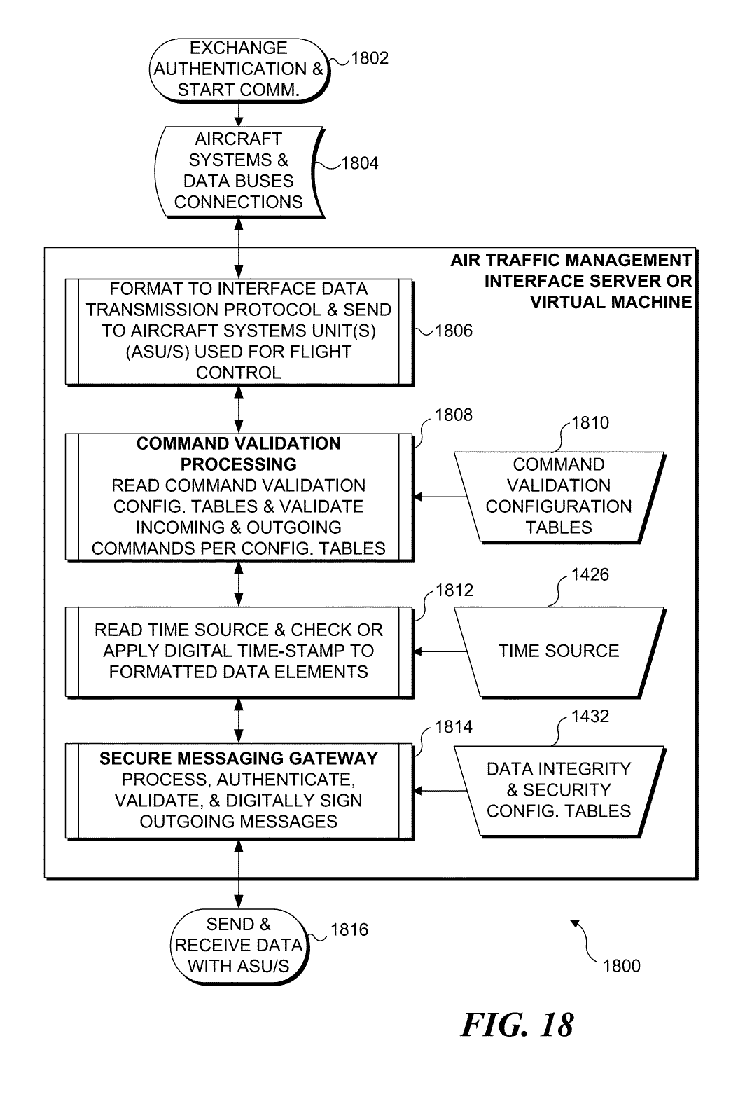

Details of an exemplary air traffic management interface server or VM 1800 are shown in FIG. 18. When communication with air traffic control is initiated, there is an exchange of authentication between air traffic management interface server or VM 1800 and the air traffic facility, and once completed, communication is started, as indicated in a block 1802. The communication is then allowed (read only) access to the core aircraft systems and core data buses connections, as indicated in a block 1804. Within the air traffic management interface server or VM, a block 1806 formats the communication to interface with the data transmission protocol and sends the formatted communication to the ASU(s) handling aircraft flight control. A block 1808 provides for command validation processing. In this portion of the procedure, command validation configuration tables 1810 are read, and the parameters provided therein are used to validate incoming and outgoing commands. Next, in a block 1812, time source 1426 provides a current time that is read and is used to check the time stamp, or the time stamp is applied to the formatted data elements. Data integrity and security configuration tables 1432 control the secure messaging gateway in a block 1814, which processes, authenticates, validates, and digitally signs outgoing messages. Finally, a block 1816 provides for sending and receiving data using the ASUs.

In FIG. 19, an exemplary customer/partner facing ground service unit 1900 is illustrated. Again, since many of the components and functionality of this unit are similar or identical or similar to those of ASU 1500, or typical ASU 1600 (in FIGS. 15 and 16), the same reference numbers are used to identify such components and functional aspects. However, in this service unit, a secure messaging gateway 1904 is employed to send and receive data with aircraft facing ground systems, as indicated in a block 1902. Once processed by secure messaging gateway 1904, the data that is received is provided to system virtual machines 1602. The system virtual machines include communications proxy service 1502, multi-link management and messaging routing services 1508, customer platform management services 1908, and customer management services 1910. The system virtual machines interact with applications supporting virtual machines 1604 and 1606, for example. Also included are data handling configuration tables 1424, time source 1426, system services communication and application configuration tables 1428, a data store 1912, and data integrity and security configuration tables 1432. Security services module 1512 is employed by system virtual machines 1602 and in the transmission and receipt of data with existing or new other onboard servers (i.e., not part of the Platform) per link, as indicated in block 1504. The transmission and receipt of data occurs in connection with communication with customer-partner interfacing systems, as indicated in blocks 1906.

Details of an exemplary customer/partner interfacing system 2000 are illustrated in FIG. 20. Again, the customer/partner interfacing system includes similar component as the ASU, so the same reference numbers are used to identify them. For example, security services module 1512 is used in sending and receiving data with customer-partner facing systems, as indicated in blocks 2002. Once data that is thus received is processed by the security services module, it is provided to system virtual machines 1602, which include communications proxy service 1508, multi-link management and messaging routing services 1508, customer platform management services 1908, and customer management services 1910. Security services module 1512 is also used for sending and receiving data with customer-partner operated ground systems, as indicated in a block 2004. System virtual machines 1602 interact with application supporting virtual machines 1604 and 1606. Also included are data handling configurations tables 1424, time source 1426, system, services, communication and application configuration tables 1428, data store 1912, and data integrity and security configuration tables 1432.

### Further Details and Benefits of Both the Airline Service and Customer Service Platforms

Through the capabilities of the multi-link management and message routing services in block 1508 and security services module 1512, the Aircraft Service Platform can support Internet and cell phone connectivity for both passenger and airline operational usage. Passengers benefit from enhanced in-air connectivity and a wider variety of available services. However, there is a further benefit to Airline Operations Centers (AOC) and aircraft crews (cabin crew and flight deck), since they can receive more data—faster—via the Customer Service Platform providing improved aircraft operational performance, enhanced air-to-ground voice and data communications with the AOCs, the ability to install new onboard applications to digitally integrate an aircraft fully into the airline's operations and incorporate digital management systems, improving airline operational efficiency, corporate planning, and reducing ground turn times. Future benefits include the ability to install new, next generation air traffic management systems onto legacy aircraft, with the addition of ASU or VM 276, and air traffic management interface server or VM 274, if such systems are not already installed.

For passengers, the new communication system offers Internet connectivity (i.e., enabling passengers to connect their mobile devices to the Internet via Wi-Fi access point (PAX) 228, GSM/UMTS access point 226 (for voice and texting), enhanced in-flight entertainment (IFE) server(s) 230, or Skype or other Voice-over-IP (VoIP) communications via platform services virtual machine 1414. By using the capabilities of the Aircraft Service Platform, passenger communications, although utilizing the same communications links as the airline communications, are digitally isolated from the aircraft communications using the latest cyber security and encryption techniques provided in secure network segment(s) 241, extending through the ground infrastructure and terminating at an Internet service provider facility that is completely outside and isolated from the ground Aircraft Service Platform components. These connectivity functions can thus provide numerous opportunities for an airline to offer many new services and flight communications options to their passengers.

To realize such operational benefits, the novel distributed communications and computing Platform used in the communication and computing system collects real-time data from the multiple operational systems on the aircraft via one or more aircraft interface device, server, or VM(s) 1712, which are significant components of the Aircraft Services Platform, using multi-link management and messaging routing services in block 1508 and the link management rules loaded from system services communication and application configuration tables 1428. The Platform employs these components to select the optimum data communications pathways from the aircraft to the ground station based on link availability, message priority, and usage rules, and may transmit the collected data to an associated ground system based on data handling configuration tables 1424 that are loaded into onboard data management services in block 1522, which is also part of the new communication and computing system. Alternatively, the Platform can temporarily store the data in onboard data store 1430 of the aircraft until an appropriate link and/or capacity is available for transmission of the data to the ground system. As described in more detail below, an aircraft facing ground server unit 1700, which is shown in FIG. 17, stores the aircraft data that is received from the aircraft in a local storage repository, verifies receipt and integrity of the data, and optionally, delivers the data to AOC applications and AOC users—all according to a data handling configuration tables 1424 that are loaded into the ground component of the onboard data management services in a customer/partner facing ground server unit(s) 1900 (shown in FIG. 19 and discussed in more detail above). AOCs that have the technical ability can directly consume the data feeds from the aircraft in real-time. Additionally, this novel system (including the aircraft-data repository) can enable the creation of new, data-rich applications to dramatically improve the operational efficiency, and customer service and can reduce fuel usage, lowering the environmental impact on airline companies and on airlines in the global aviation industry that have installed and execute such applications, for example, using applications VMs 1422a or 1422b.

The novel distributed service Platform and its associated communication and computing system is not a single monolithic box. Instead, it is a system of systems, as shown in FIG. 2B, comprising both the Aircraft Service Platform that spans an airline company's entire fleet of aircraft and includes both onboard and terrestrial components, and the Customer Service Platform that links the airline's IT infrastructure to the Aircraft Service Platform, as discussed in detail herein. These components are designed to support a wide range of operational applications for the aviation industry, as well as providing enhanced services for airline passengers. An exemplary embodiment of this new communication and computing system comprises the core elements discussed herein.

This technology thus provides a global communications system for commercial aircraft that includes the ability to select and use the “current-best” link (based on aircraft position, link cost, etc.) through multi-link management and messaging routing services in block 1508 in cases where the aircraft has multiple communication link technologies available. Using the present novel approach, onboard network access components (i.e., Wi-Fi access points, Global System for Mobile communications (GSM) pico-cells, etc.) enable various types of wired and wireless devices, as shown in the lower part of FIG. 2A, to take advantage of any broadband communications link installed on an aircraft.

The Aircraft Service Platform includes ASU or VM 276″ that is used to host and deliver various application services for the airline company, and Internet and cell phone connectivity for the passengers and crew, all onboard the aircraft. Aircraft interface device, server, or VM 1712 and AID 1308 are provided as part of the Aircraft Service Platform to collect data from multiple aircraft systems, including core aircraft systems. The Aircraft Service Platform components then tag the data with trusted time and origin metadata, check for onboard storage requirements, and if marked for ground storage, then securely transmit the data to the ground in near real-time. AID 1308, discussed above in connection with FIG. 13, is also designed so that at a hardware level, it can only “read from” or “listen to” the core aircraft systems and core data buses, which ensures that the onboard service of the Platform cannot, in any way, interfere with the core components of the aircraft. In addition, ASU 1500 can receive data from the ground-based components and distribute the data to the appropriate applications or sub-services within itself or peer ASU or VMs 276 comprising the Aircraft Service Platform, or to other systems on the aircraft, as shown in FIG. 2A, so as to improve operations, performance, and customer service.

Also as shown in FIG. 15, ASU 1500 supports interfaces that enable data to be sent and received, as indicated in block 1518, to and from AIDs, and to and from onboard sensor suites for both airline operations (e.g., baggage, occupancy, equipment inventory, etc.), and aircraft environment and health monitoring. Ground-based systems are included in the overall system and are responsible for long term storage and management of the collected aircraft-data and for providing controlled, authorized access to that data via real-time data feeds, bulk data movement, and standardized application interfaces. A stable, optimized interface with the airframe's non-flight critical systems (i.e., existing or new onboard servers and onboard crew interface devices, as indicated in block 1506), such as aircraft health management and EFB, is provided by communications proxy service 1502, which maximizes data transfer performance with protocol optimization, enables data to be transferred off the aircraft using new higher performance links and protocols, provides a single point of authentication, and readily accommodates changes in link or ground services, but does so without the need for such changes to be recertified. Recertification is not required because these certified systems previously installed on the aircraft then do not need software updating, since they have a stable unchanging link with the onboard Platform components, where changes can occur without the need for recertification.

ASU 1500, which is an important component of the Aircraft Service Platform, adds a new dynamic layer of cyber security protection to the aircraft for near real-time response to cyber threats or environmental changes in security services module 1512. A key concept is that the architecture of the novel onboard distributed service Platform enables all of these functions and additional capabilities to be added, modified, or performed on an aircraft without impacting the certification of the aircraft core communications systems and servers, which have an unchanging interface through the transmission and receipt of data in block 1504, via communications proxy service 1502.

The new distributed communications and computing Aircraft Service Platform is an open platform from a software view—although, for reasons of data privacy, it is not a public Platform. Instead, it creates a “closed/private/secure” system of systems environment that extends the airline company's existing ground infrastructure to the aircraft using a distributed system, virtualization, and cyber security technology, as shown in FIG. 2B. This approach provides a unique application of these technologies to commercial aviation. Further, the communications and computing services within the Aircraft Service Platform provide standardized application-hosting environments on the ground and on the aircraft, as well as a set of consistent, managed, and secure communications services for airplane-data acquisition, air/ground data exchange, data persistence and management, and data analysis, using the concept of “Platform as a service,” as discussed herein. Taken together, the hosting and data services address the most fundamental needs of modern, connected applications, i.e., memory, computation, and communications, enabling the extension of traditional corporate operations and back office systems to be extended to include systems and software onboard the aircraft. Airline back office systems interface with the Customer Service Platform, which then interfaces via “secure messaging gateways” with the Aircraft Service Platform on each aircraft, to connect the back office systems to all of the aircraft in an airline's fleet.

The new Platform as a service architecture enables third-party software developers to deliver arbitrary operational or passenger applications that run on the Platform without the need to construct complex hardware and software systems onboard the aircraft. This enhanced application facility enables developers to focus on the core functionality of their own applications and results in faster time-to-market and lower investment costs, versus the traditional “siloed” approach normally employed for developing aviation software applications. The term “siloed” refers to the current approach in which aircraft systems are developed as single point solutions, without any provision for adding functionality to an existing aircraft system.

The communications and computing service Platform also protects the aircraft via a true-layered security architecture that is employed in security services module 1512, including strong authentication of connected systems and applications, multi-layered encryption, and two “closed computing clouds.” The Aircraft Service Platform and the Customer Service Platform only communicate externally via military-style “secure message passing gateways.” This approach precludes any Internet traffic from reaching the aircraft core systems, thereby minimizing cyber threats to the aircraft. The system also uses double digital signing of software to facilitate checking software signatures in security services module 1512 on startup and to ensure that any compromise of a single “public key infrastructure” provider does not leave the aircraft vulnerable to cyber attacks. The approach further uses aircraft hardware systems that can only “listen” to the core aircraft systems and buses, but which are physically incapable of sending any type of signal to a core aircraft system or core data bus that might interfere with the certified core components.

### Closed Network System of Systems and Application of the Platform to a Fleet of Aircraft

The Aircraft Service Platform is not an avionics box. Instead, it is a system of systems, as depicted in FIG. 2B, in which each system provides a virtualized environment, as shown in FIG. 11. The virtualized environment extends the ground communications interface systems to include the edge of the aircraft and the edges of the infrastructures of the airline and application service providers. This approach solves the problem of integrating an aircraft into the airline's digital infrastructure without impacting aircraft certifications. The communication and computing implemented by the Aircraft Service Platform is thus a “closed network system of systems,” which is completely isolated from the global Internet (although other portions are not). When viewed from the perspective of an airline that uses the present technology on all of its aircraft, the Aircraft Service Platform contains its onboard aircraft systems for each aircraft equipped with it in the aircraft operator's fleet, and extends the airline's ground equipment and systems supporting these aircraft to the aircraft, enabling the airline to manage these aircraft as “truly connected” parts of their infrastructure. It also enables the airline to obtain aircraft data that was previously inaccessible, to manage data flow to and from the aircraft fleet, and to install and manage new onboard applications running on aircraft in the fleet.

### Distributed Computing and Communications Platform

The Aircraft Service Platform is an open and distributed application Platform, designed to enable rapid deployment of applications for commercial aircraft. The Aircraft Service Platform provides a complete solution and includes core onboard and ground-based Platform elements and a set of baseline applications and services. The Aircraft Service Platform acquires operational data from a variety of aircraft systems and then securely distributes this data for use by Platform-hosted applications (which can run on VMs and thus be isolated from each other), customers, and partners. Application programming interfaces (APIs) enable authorized applications, customers, and partners to access aircraft operational data as necessary to support their business processes. The Platform approach used in the present technology provides the following functionality and features:
Greatly enhanced onboard data collection, including the ability to integrate with the airplane's core systems, various aircraft core data buses, and sensor suites via aircraft interface device 280 or aircraft interface device, server or VMs 282 that are hosted in ASUs or VMs 276;
Application hosting capabilities in the ASUs or VMs 276, or in customer or partner interfacing ground servers or VMs 288, or in customer or partner facing ground servers or VMs 290, or in aircraft facing ground servers or VMs 292, as appropriate, thereby supporting passengers, cabin crew, pilots, and airline back-offices, while eliminating the need for application developers to provide custom hardware;
A set of standard onboard platform management services, as noted in block 1510, which are implemented by the ASUs and are designed to support all phases of an application and Platform lifecycle, from initial deployment, through daily operation;
The capability to securely move data between applications and associated systems, including air-to-ground and ground-to-air data movement services, over any available communication links, such as legacy aviation, new Internet, and new non-Internet protocols and links 278, and between the aircraft and the ground infrastructure, which are provided by onboard data management services 1522, and are implemented by the ASUs; and
The Customer Platform is entirely ground-based and includes a common service portal, such as customer or partner interfacing ground servers or VMs 288, which enables airline customers to access application interfaces, billing, reporting and data analysis, where these functions can be implemented either by one or more physical servers or VMs interfacing to the airline's back office systems.

### Adaptability

The Multi-Link Management and Communications Bridge components provide cyber security implementation and cyber security configuration management for each Remote Node—enabling them to adapt to emerging threats to the network and data. This function is performed via security services module 1512 in ASU 1500, shown in FIG. 15. The security services read or load data integrity and security configuration tables 1432 then apply the designated security services, including authentication parameters, link usage authorization, intrusion detection, message scanning, firewall rules, etc. to the available links. The security services also receive continuous aircraft position data and updates of the current national airspace status from onboard platform management services in block 1510, which are received as part of the data transmitted and received with AID(s) and sensor suites, in block 1520. When changes occur in the national airspace, security services module 1512 also updates the security parameters it employs with any relevant changes, such as modifying firewall rules to block access to various web services or to provide “legal intercept” of passenger traffic as required to meet changes in the state of current national airspace where the aircraft is flying. In addition, onboard platform management services in block 1510 of the Aircraft Service Platform ground server unit can command updates of ASUs or VMs 274 through its onboard platform management services in block 1510, to update or replace data integrity and security configuration tables 1432, or to update, add new security services, or entirely replace security services module 1512 with a new version.

Applications executed on both the Aircraft Service and Customer Service Platforms are accessible through onboard data management services in block 1522, and data produced by such applications is managed, stored, and made available through standard application programming interfaces (APIs). Data collection, storage, and application access to the data is managed in accord with data handling configuration tables 1424, which are loaded into the onboard data management services in block 1522. Data handling configuration tables 1424 can be changed or updated as required by onboard platform management services in block 1510, to satisfy operational data needs, airline requirements, or the needs of other external consumers. Additionally, applications can use onboard platform management services in block 1510 to exchange data with one or more other applications, regardless of whether those applications are hosted on one or more Remote Nodes comprising ASUs or VMs 276, or on customer or partner facing ground servers or VMs 290, or on Central Nodes comprising aircraft facing ground servers or VMs 292, or on customer or partner interfacing ground servers or VMS 288, which can be located in an external consumer's facility.

### Communications Proxy Service

The use of communications proxy service 1502 in both the Central Node that is coupled to the aircraft core systems, and Remote Nodes provides a mechanism for concealing the implementation details of the communication functionality of legacy or proprietary communication protocols from the data management services and the applications. The communications proxy service provides the means for separating the processing of communication control interfaces from the data being sent through the layers.

Communications proxy service 1502 resides between the software systems receiving the data and any legacy communication links. The communications proxy service provides protection to the data flow between legacy communications infrastructures and the legacy software systems, by implementing communication controls on the computing resources in the Remote Node of the service.

By generalizing the access to communication link options, the communications proxy service enables multiple communication links to be used in a consistent and simple way, despite age or implementation details of those communication links. The producers and consumers of any particular communication link need only interface with the communications proxy service, and as described above, the communications proxy service will apply security and processing steps to the data flow before connecting to the selected communication link system. The communications proxy service is also the design element that ensures communication with the aircraft core systems is stable, optimized, and immune to link, protocol, or cyber security changes, and is maintained exactly as it was at the time of its original construction and installation.

### Other Communications Proxy Service Functionality

The communications proxy service implements several additional functions. Specifically, it:
Protects the communication links from direct use by components that are partitioned or separated from the Platform and neighboring applications;
Carefully controls the parts of the system that are allowed access to certain communication links—enabling the use of restricted communication link types, by adjudicating the types of data, quantities of data, and circumstances under which data is allowed to flow over the communication links;
Brings security layers and processing pipelines that implement security algorithms to the communication links;
Controls the incoming and outgoing network traffic by analyzing the data packets and determines whether data should be allowed through, based on a predetermined rule set (provided at least in part by the data integrity and security configuration tables);
Examines traffic for attempts to tamper with the data sent over the communication links in order to subvert the communication traffic processing software on the other side; and
Examines traffic for malware (viruses, backdoor attempts, etc.), applies security signatures to check communication authenticity, and applies cryptographic protection to the data flow traffic.

Most legacy communication systems were not designed to be exposed to such threats. Thus, by using the communications proxy service in the Platform, these legacy unprotected links can be protected from cyber threats, because the legacy communications are encapsulated and are passed unchanged, with outer security layers added by the system to ensure authenticity and integrity.

### Dynamic Configuration Management Service

The Aircraft Service Platform also contains a dynamic configuration management service as part of the onboard platform management services in block 1510 (and in corresponding blocks 1712 and 1910). This configuration management service provides continuous aircraft location information to communications proxy service 1502, multi-link management and messaging routing services in block 1508, onboard platform management services in block 1510 (and in corresponding blocks 1710 and 1908), and security services module 1512. Due to differences in national laws in various countries around the globe through which an aircraft may be passing, the aircraft must be able to change communication parameters and security settings to conform to those laws. These changes may include bans on certain websites and content filtering, or allowed/required communications authentication or encryption. Also, each different communication or link service provider may use different types of routing address management and other supporting networking communication services. Thus, as the aircraft crosses into different national airspaces or communicates with different service providers, it must be able to dynamically adjust the security network and communication services during flight. The dynamic communication configuration management functions of ASU 1500 constantly monitor the aircraft position for changes in national airspace and the communication links, and for changes in communication service providers. Whenever such changes occur, the dynamic configuration management service then checks the changes against data handling configuration tables 1424, and where appropriate or required, makes the necessary changes in either the security, communications, or network services configurations and rules that are applied, including restarting a link if necessary. This service ensures that the aircraft can operate globally with minimal disruption in communication services and can automatically adjust to changes as the aircraft passes over different national countries/regions, to conform to the laws or regulations of those countries/regions.

### Service Cyber Security

The architecture of the Aircraft Service Platform ensures that it cannot introduce cyber security threats to the aircraft core systems, since it incorporates “read only” or “listen only” interfaces to these critical systems, thus ensuring that the Platform cannot interfere with aircraft flight critical systems. The Platform incorporates layers of modular cyber security. It is constructed of two Platform segments, including the Aircraft Service Platform (which provides remote facing data and services), and the Customer Service Platform (which provides customer facing services), as shown in FIG. 6. The Aircraft Service Platform includes Remote Nodes for aircraft 606, the communications links between the aircraft nodes and the ground, and the ground-based components facing the aircraft, including management processing, and storage. The Aircraft Service Platform containing its remote aircraft nodes and processing relative to core systems is completely isolated from the Internet. Incoming or outgoing data, messages, or controls are passed from the Customer Service Platform via secure messaging gateways 1904 and 1708.

The Aircraft Service Platform uses a security concept that permits no human users, systems, links, or applications to authenticate to each other. When necessary, human authentication is done only with the device a particular person is using. Aviation fundamental aircraft security, which provides access to the aircraft by crew, maintenance, and operations personnel, is physically controlled, and this same physical access control exists throughout the industry. Platform operational staff are also subject to physical access control. This concept limits the number of security interactions required by the Aircraft Service Platform. The security control uses a public key infrastructure (PKI) for authentication and encryption, as well as private network services in security services module 1512, but the security services can be modified, if needed, to use private keys.

The Customer Service Platform implements the same control concepts between itself and the customer/partner Remote Nodes, with all authentication and encryption being implemented between systems, communication links, and applications. This Service also nominally uses a PKI for authentication and encryption, and where required, can use industry PKI bridges like the aviation industry's CertiPath, standard commercial PKI services, or a private key infrastructure—if desired by the customer.

### Virtualization

FIG. 11 illustrates the Virtualization and Partitions that the Platform includes. The Platform uses VM's as containers for core Platform services and hosted applications. A VM is a software implementation of a machine (i.e., a computer) that executes programs like a physical machine. It uses VM's to segregate and isolate software elements of the Platform from one another, for the purposes of security and resource management.

From a security perspective, software elements with different security characteristics are allocated to different VMs, so as to minimize the opportunities for a digital attack on the most sensitive elements of the Platform. For example, consider a hypothetical “Element A” that provides secure services to aircraft flight crew, and a hypothetical “Element B” that provides entertainment services to passengers; each of these elements is allocated to a different VM and communicates on different virtual networks that are isolated from each other.

From a resource management perspective, the virtual-machine manager is hypervisor operating system 308; it manages the execution of one or more “guest” VM's, such as virtual hardware 306a or 306b, on a “host” machine, i.e., physical hardware 314. The VM manager has the ability to constrain the computing resources that are allocated to any VM and, by extension, to any software elements that are deployed on that VM. Critical elements of the Platform are deployed separately from applications developed by third-parties, so that undesired or unpredictable resource consumption on one element has minimal effect on another element that is deployed in a separate VM. Vulnerability and computing resource requirements (e.g., applications or services with variable resource requirements) can be deployed in VMs to constrain the use of resources.

Virtualization decouples guest VM's and any software deployed therein, from underlying physical hardware 314. By emulating the underlying physical hardware, such as in virtual hardware 306a or 306b, the VM manager enables VMs to be portable across any physical hardware, in either Platform supported by the VM manager. Virtualization also facilitates easy replacement of onboard hardware with similar or enhanced physical hardware, because the virtualized hardware is isolated from physical hardware dependencies. This feature is similar to a commercial OS like Microsoft Corporation's WINDOWS™ OS, which can be loaded onto almost any vendor's computer system and which detects the underlying hardware so that it loads the specific drivers and interfaces needed to utilize that hardware.

Exemplary onboard platform 1100 shown in FIG. 11 illustrates how virtual machines segregate Platform elements from one another and how VMs can be used (i.e., for ASU or VMs 276, aircraft facing ground servers or VMs, 292, customer or partner facing ground servers or VMs 290, or customer or partner interfacing ground servers or VMs 288—see FIG. 2B). It should be understood that it is possible to have more or fewer VMs than are illustrated in the example shown in FIG. 11, but the VMs can be configured in a manner similar to that shown in this Figure.

### Aircraft Core Isolation Architecture

The Platform architecture isolates and protects the interfaces of upstream aircraft telemetry systems and safety-sensitive avionics by employing separate onboard hardware device(s), known as SIDs. On the Aircraft Service Platform, the SID elements connecting to aircraft core systems is aircraft interface device, server or VM 282, or air traffic management interface server or VM 274 (see FIG. 2B). Read-only access mitigates the impact of any Platform malfunction to other aircraft systems and avionics, which is an important Federal Aviation Administration (FAA) consideration. Additionally, by partitioning existing aircraft equipment and systems apart from the Platform's primary computing unit, memory, data storage, and networks, the architecture reduces potential vulnerabilities and threats such as computer viruses, worms, unauthorized access, and malicious access. One-way data communication relative to the aircraft core systems further ensures airplane systems are protected from unintentional or mischievous activity. Such segregation also enables continuous innovation and updating of Remote Node services, software, and applications—all without recertifying the Platform or components installed on the aircraft that are not part of the Platform.

Authentication and encryption between Platform systems, applications, and links is nominally done through the use of PKI technology. If other authentication or encryption technologies are required at some point, Kerberos, private key exchanges, or evolving new standards like Policy Augmented S/MIME (PLASMA) or elliptic curve encryption can be utilized, with only changes to the aircraft configuration file being carried out, as required.

The system also incorporates standard anti-virus technology on all communications traffic and messages between the remote aircraft node and the ground systems. Further, as new cyber security technology is developed and becomes available, the Platform can seamlessly install this new technology to further control the communications links and message traffic, with no impact to the installed applications or platform services.

Additionally, communications proxy service 1502 adds still another protection layer, since it controls all communications to and from non-Platform systems on the aircraft.

### Advanced Air Traffic Management Service

To add the capability to support new advanced air traffic management services, secure messaging gateway 1708 having military style characteristics is included in the Aircraft Service Platform for the ground infrastructure, to receive and send advanced air traffic management directions with regard to national air navigation service providers, like the FAA and Eurocontrol. An additional secure messaging gateway VM (not separately shown) is also included in each aircraft Remote Node for carrying these messages to and from the aircraft core flight management systems. These secure message gateways can use either PKI or private (hand installed) digital keys and can send or receive their digitally signed and encrypted messages over any available communications link with the aircraft.

A micro-server “line replaceable unit” (LRU), air traffic management interface server or VM 274, corresponding to air traffic management interface server or VM 1800, which is shown in detail in FIG. 18, is included in the onboard remote node (not separately shown) to provide a last link for carrying these messages to the aircraft flight management systems. Once a message is processed through the end of the secure message gateway chain, it is then passed to the message and command authentication and validation system for further command checking for message expectation, command parameter validation, hysteresis validation, system destination or origin validation, and other checking, as may be required by aircraft certification regulations for advanced air traffic management. Once the validation system completes checking and validating the message or command, the message or command is then passed to the flight management system or to other aircraft core systems that are designated in the message or command.

Other Applications of this Technology

Although the discussion of exemplary embodiments of the present novel approach that is set forth herein relates to its application to aviation, it should be understood that this new technology can be beneficially used in connection with any critical infrastructure segment or high security environment (e.g., SmartGrid, Health, and Banking, to name a few, but without any implied limitation), to create a secure system of systems distributed computing and communication environment. For example, the present approach can provide flexible, secure edge services to a remote banking customer, or to an operating room or ICU at a medical facility, or can provide continuous patient health status monitoring, or monitoring of power transmission substations or generating plants. In the more general sense, the present approach can be used for enabling distributed computing and secure communication of data between a first entity (which would correspond to an aircraft in the exemplary application of this technology to aviation that is discussed above) and any of one or more second entities (which would correspond to one or more ground stations in this exemplary application). It will thus be evident that this technology is applicable to many very diverse fields and is not in any way limited to use in aviation.

This approach can use any legacy, existing, or new communications links/services to provide these services and functionality. As an example, implanted or wearable medical devices, such as insulin pumps or implantable cardio defibrillators/pacemakers, can wirelessly transmit their status to proprietary devices when in range, and these proprietary devices can then retransmit the status information to a health care provider at a remote location via the Service Platform described above. Also, numerous wearable systems and portable systems exist that have storage, and these systems can implement data processing, using standard non-proprietary wireless communications. Examples include without any implied limitation, the Apple iPhone™, other types of smart phones, pedometers, “Fitbits,” etc. This technology enables these types of systems to directly interface to medical devices on or in the body of the person wearing or carrying the portable communication device, providing the person with local storage, processing, and standard, widely available communications links, as needed. Accordingly, it is not intended that the scope of these concepts in any way be limited by the description provided herein in regard to its application to aircraft and aviation ground stations.

Although the concepts disclosed herein have been described in connection with exemplary embodiments for practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

What is claimed is:

1. A system for enabling distributed computing and secure communication of data between a first entity and any of one or more second entities, wherein the first entity, and each of the one or more second entities are geographically separated from each other, comprising:
(a) one or more first entity computing devices disposed at the first entity, each of the first entity computing devices executing machine instructions to perform one or more defined functions, wherein the first entity comprises one or more critical elements, the one or more first entity computing devices being precluded from modifying or otherwise affecting the one or more critical elements, wherein the one or more defined functions comprise monitoring at least a plurality of the one or more critical elements to obtain, distribute, or process data either locally or remotely;
(b) one or more second entity computing devices disposed at each of the one or more second entities to perform one or more other defined functions, at least one of the other defined functions comprising using the data obtained by the first entity computing devices monitoring the one or more critical elements of the first entity; and
(c) one or more data links coupling the one or more first entity computing devices in secure data communication with the one or more second entity computing devices, so that data from the one or more first entity computing devices is transferred securely to the one or more second entity computing devices.

2. The system of claim 1, wherein the first entity is mobile, and wherein a plurality of the second entities comprise systems that are disposed at disparate fixed locations.

3. The system of claim 1, wherein data links comprise wireless transmissions between the first entity and the one or more second entities.

4. The system of claim 3, wherein at least some of the wireless transmissions are conveyed through one or more satellites orbiting the earth.

5. The system of claim 1, wherein the first entity comprises a system of systems installed on an aircraft, the one or more second entities comprise one or more customer or partner systems disposed at disparate locations on the ground, and one or more aircraft service ground systems, and the one or more critical elements comprise one or more core systems and core data buses on the aircraft, further comprising a plurality of first operational entities, each comprising a system of systems installed on a plurality of aircraft of an airline company, each system of systems installed on the plurality of aircraft transmitting data monitored on the one or more core systems and one or more core data buses of the aircraft to the one or more customer or partner systems, and to the one or more aircraft service ground systems.

6. The system of claim 5, wherein the data obtained by the system of systems on an aircraft includes data obtained by monitoring at least one of: other onboard computing devices, onboard avionics interface devices, aircraft sensor suites, aircraft flight control systems, aircraft data buses, or networks of the aircraft.

7. The system of claim 5, wherein the data obtained by the system of systems on an aircraft includes data that is exchanged bi-directionally between passenger electronic devices and ground systems, and wherein the data obtained comprises at least one of Internet data communications, cellular telephone communications, or text communications.

8. The system of claim 5, wherein the data obtained by the system of systems on an aircraft includes data provided by at least one of crew electronic devices, or operational devices on the aircraft, which are not operated by any passenger.

9. The system of claim 5, wherein the systems of systems installed on an aircraft comprises one or more aircraft server units, each of which includes a security services module for facilitating secure bi-directional data communication with the one or more customer or partner systems on the ground and with the one or more aircraft ground systems.

10. The system of claim 9, wherein at least one aircraft server unit on an aircraft executes one or more system virtual machines that run software applications to provide data communication and management services and which use the security services module for securely communicating data bi-directionally with ground systems via at least one of active non-Internet protocol data links, or active Internet protocol data links.

11. The system of claim 9, wherein the security services module employs a layered security architecture to protect communication with the one or more customer or partner systems, and wherein the layered security architecture precludes any Internet communications from reaching the core systems and core data buses of an aircraft and uses double digital signing of software to facilitate checking software signatures on startup and to ensure that a compromise of a public key infrastructure provider does not leave the aircraft vulnerable to cyber attacks.

12. A method for enabling distributed computing and secure communication of data between a first entity and any of one or more second entities, wherein the first entity, and each of the one or more second entities are geographically separated from each other, comprising:
(a) performing one or more defined functions that include monitoring one or more critical elements of the first entity to obtain data, while being precluded from modifying or otherwise affecting the one or more critical elements;
(b) securely transferring the data monitored by the first entity to the one or more second entities or one or more data links; and
(c) performing one or more other defined functions at each of the one or more second entities, at least one of the other defined functions comprising using the data obtained by the first entity as a result of monitoring the one or more critical elements of the first entity.

13. The method of claim 12, further comprising bi-directionally transferring data over the one or more data links while the first entity is mobile, wherein a plurality of the second entities comprise systems that are disposed at disparate fixed locations.

14. The method of claim 12, wherein at least a portion of the data that is monitored by the first entity is securely transferred wirelessly between the first entity and the one or more second entities.

15. The method of claim 14, wherein wirelessly transferring the data comprises transferring at least some of the data through one or more satellites orbiting the earth.

16. The method of claim 12, wherein the first entity comprises an aircraft, the one or more second entities comprise one or more customer or partner systems disposed at disparate locations on the ground, and one or more aircraft service ground systems, and the one or more critical elements comprise one or more core systems and one or more core data buses of the aircraft, further comprising a plurality of first operational entities, each comprising a system of systems installed on a plurality of aircraft of an airline company, each system of systems installed on the plurality of aircraft transmitting data monitored on the one or more core systems and one or more core data buses of the aircraft to the one or more customer or partner systems, and to the one or more aircraft service ground systems.

17. The method of claim 16, wherein the system of systems on an aircraft obtains data by monitoring at least one of: other onboard computing devices, onboard avionics interface devices, aircraft sensor suites, aircraft flight control systems, aircraft data buses, or networks of the aircraft.

18. The method of claim 16, wherein the system of systems on an aircraft handles a bi-directional exchange of data between passenger electronic devices and ground systems, and wherein the data that is exchanged comprises at least one of: Internet data communications, cellular telephone communications, or text communications.

19. The method of claim 16, wherein the system of systems on an aircraft handles a bi-directional exchange of data between ground systems and at least one of crew electronic devices, or operational devices on the aircraft, which are not operated by any passenger.

20. The method of claim 16, wherein the system of systems uses a security services module for facilitating secure bi-directional data communication with the one or more customer or partner systems, and with the one or more aircraft ground systems.

21. The method of claim 20, further comprising executing one or more system virtual machines on the system of systems for providing data communication and management services, and using the security services module for securely communicating data bi-directionally with ground systems via at least one of active non-Internet protocol data links, or active Internet protocol data links.

22. The method of claim 20, further comprising employing layered security architecture with the security services module for protecting communication with the one or more customer or partner systems, wherein the layered security architecture precludes any Internet communications from reaching the core systems and core data buses of an aircraft and uses double digital signing of software to facilitate checking software signatures on startup and to ensure that a compromise of a public key infrastructure provider does not leave the aircraft vulnerable to cyber attacks.

23. The method of claim 16, further comprising isolating the system of systems on an aircraft from the one or more core systems and one or more core data buses of the aircraft so that changes in software or hardware within the system of systems can be implemented without requiring any recertification of any portion of the aircraft by a regulatory agency.

24. An add-on communications system for use on an aircraft, for securely managing communications between the aircraft and ground stations, including legacy communications, so that changes to the add-on system do not require recertification of any portion of the aircraft by a regulatory agency, comprising:
(a) a computing device that is installed on the aircraft and is coupled to receive data from core systems and core data buses of the aircraft, but which is not part of the core systems of the aircraft, and which is unable to cause any changes to either the core systems or the core data buses of the aircraft;
(b) a communications proxy service module provided in connection with the computing device, for transmitting to or receiving data in regard to components of the core systems, or new components that are not part of the core systems and in regard to crew interface devices that are used on the aircraft;
(c) a security services module that is coupled to the communications proxy service module; and
(d) a multi-link management and messaging routing services module that is employed to transmit and receive data using the security services module to control the security of the data that is transferred bi-directionally with ground stations via at least one of active Internet data links, or non-Internet protocol data links, wherein the multi-link management and messaging routing services module selects a best communication channel from among a plurality of available communications channels based on current aircraft flight characteristics and other considerations, including a geographical location of the aircraft within country boundaries, conformance to government regulations, and quality of communication, using data links on the plurality of available communication channels.

25. The add-on system of claim 24, further comprising data integrity and security configuration tables that provide guidelines and rules employed by the security services module for controlling the security of data that is transferred bi-directionally with the ground systems, wherein the data integrity and security configuration tables can be modified or replaced as appropriate to achieve desired changes in the add-on system functionality, without requiring recertification of any portion of the aircraft by any regulatory agency.

26. The add-on system of claim 24, wherein the multi-link management and messaging routing services module is aware of the aircraft location when managing communication link configurations, and uses the security services module to dynamically reconfigure data communication channels so as to achieve data link cyber security, independent of at least one of a data link provider employed for communication, or airport connectivity services that are employed by ground stations to communicate with the aircraft.

27. A method for using an add-on system on an aircraft for securely managing communications between the aircraft and ground stations, including legacy communications, so that changes to the add-on system do not require recertification of any portion of the aircraft by a regulatory agency, comprising:
(a) installing a computing device on the aircraft that is coupled to receive data from core systems and core data buses of the aircraft, but is not part of the core systems of the aircraft, and which is unable to cause any changes to either the core systems or the core data buses of the aircraft;
(b) providing a communications proxy service module in connection with the computing device, for transmitting to or receiving data in regard to components of the core systems or new components that are not part of the core system, and in regard to crew interface devices that are used on the aircraft;
(c) coupling a security services module to the communications proxy service module;
(d) transmitting and receiving data using the security services module with a multi-link management and messaging routing services module using the security services module to control the security of the data that is transferred bi-directionally with ground stations via at least one of active Internet data links, or non-Internet protocol data links; and
(e) using the multi-link management and messaging routing services module to select a best communications channel from among a plurality of available communications channels based on current aircraft flight characteristics and other considerations, including a geographical location of the aircraft within country boundaries, conformance to government regulations, and quality of communication, using data links on the plurality of available communication channels.

28. The method of claim 27, further comprising using predefined guidelines and rules for controlling the security of data that is transferred bi-directionally with the ground systems, wherein the guidelines and rules can be modified or replaced as appropriate to achieve desired changes in the add-on system functionality, without requiring recertification of any portion of the aircraft by any regulatory agency.

29. The method of claim 27, further comprising:
(a) enabling the multi-link management and messaging routing services to be aware of the aircraft location when managing communication link configurations; and
(b) using the security services module to dynamically reconfigure data communications channels so as to achieve data link cyber security, independent of at least one of a data link provider employed for communication, or airport connectivity services that are employed by ground stations to communicate with the aircraft.

30. An add-on computer platform for use on an aircraft in providing a plurality of functions and services to the aircraft, passengers on the aircraft, and crew members of the aircraft, comprising:
(a) at least one computing device installed on the aircraft and able to monitor and receive data from core systems and core data buses of the aircraft, but without modifying or affecting the core systems and core data buses; and
(b) a plurality of virtual machines executed by one or more of the at least one computing device, the plurality of virtual machines each executing one or more software applications to provide the plurality of functions and services, wherein the plurality of virtual machines are segregated and isolated from each other to provide enhanced security and resource management that prevent an application executed by one virtual machine from affecting an application executed on any other virtual machine.

31. The add-on computer platform of claim 30, wherein the plurality of virtual machines are substantially independent of physical hardware employed for the at least one computing device, so that changes in the hardware used for any of the at least one computing device can be made without affecting the functionality and services provided by the applications executed on the plurality of virtual machines.

32. The add-on computer platform of claim 30, wherein at least one of the plurality of virtual machines interacts with core data services and system management services on the aircraft.

33. The add-on computer platform of claim 30, wherein at least one of the plurality of virtual machines interacts with core network and traffic management services on the aircraft.

34. A method for using an add-on computer platform installed on an aircraft for providing a plurality of functions and services to the aircraft, passengers on the aircraft, and crew members of the aircraft, comprising:
(a) installing at least one computing device on the aircraft and connecting the at least one computing device so that it is able to monitor and receive data from core systems and core data buses of the aircraft, but without modifying or affecting the core systems and core data buses; and
(b) executing a plurality of virtual machines on one or more of the at least one computing device, the plurality of virtual machines each executing one or more software applications to provide the plurality of functions and services, wherein the plurality of virtual machines are segregated and isolated from each other to provide enhanced security and resource management that prevent an application executed by one virtual machine from affecting an application executed on any other virtual machine.

35. The method of claim 34, wherein changing physical hardware employed for the at least one computing device does not affect the functionality and services provided by the applications executed on the plurality of virtual machines.

36. The method of claim 34, further comprising using at least one of the plurality of virtual machines to interact with core data services and system management services on the aircraft.

37. The method of claim 34, further comprising using at least one of the plurality of virtual machines to interact with core network and traffic management services on the aircraft.
